(19) United States
(12) Patent Application Publication
(10) Pub. No.: US 2026/0276666 A1
(43) Pub. Date: Sep. 17, 2026

(54) SPECIMEN TRANSFER DEVICE AND SPECIMEN TESTING SYSTEM

(71) Applicant: Sysmex Corporation, Kobe-shi (JP)

(72) Inventors: Hidetaka HAYAMA, Kobe Shi (JP); Toshiki SATO, Kobe-shi (JP); Yuichiro OHMAE, Kobe-shi (JP)

(21) Appl. No.: 19/680,123

(22) Filed: May 18, 2026

Related U.S. Application Data
(63) Continuation of application No. 18/151,274, filed on Jan. 6, 2023, now abandoned.

(30) Foreign Application Priority Data
Jan. 14, 2022 (JP) 2022-004693
Jan. 14, 2022 (JP) 2022-004694
Jan. 14, 2022 (JP) 2022-004695

(51) Int. Cl. G01N 35/04; G01N 1/28; G01N 35/00; G01N 35/02; G01N 35/10

(52) U.S. Cl. CPC G01N 35/04; G01N 1/2813; G01N 35/0092; G01N 35/026; G01N 35/10; G01N 2035/00752; G01N 2035/041; G01N 2035/0412; G01N 2035/0424; G01N 2035/0465; G01N 2035/1051

(57) ABSTRACT

Disclosed is a specimen transfer device connected to a rack transportation path of a specimen testing system, and the specimen transfer device includes: an ascending/descending mechanism configured to move a rack between a first ascending/descending position at which the rack in a first tier is disposed, and a second ascending/descending position at which the rack in a second tier is disposed; a container transfer mechanism configured to transfer a specimen container, to a second rack disposed in the second tier, from a first rack moved by the ascending/descending mechanism from the first ascending/descending position to the second ascending/descending position; a rack waiting region disposed in the first tier and configured to cause the rack to stay in a waiting state between the first ascending/descending position and a carrying-out position to the rack transportation path; and a first transportation mechanism configured to transport the first rack moved by the ascending/descending mechanism from the second ascending/descending position to the first ascending/descending position, through the rack waiting region, to the carrying-out position.

### RELATED APPLICATIONS

This application is a continuation of U.S. application Ser. No. 18/151,274, filed on Jan. 6, 2023, which claims priority to Japanese Patent Application No. 2022-004695, filed on Jan. 14, 2022, Japanese Patent Application No. 2022-004694, filed on Jan. 14, 2022, and Japanese Patent Application No. 2022-004693, filed on Jan. 14, 2022, the entire contents of which are incorporated herein by reference.

### BACKGROUND OF THE INVENTION

### 1. Field of the Invention

The present invention relates to a specimen transfer device for transferring a specimen container held in a rack to another rack, and a specimen testing system.

### 2. Description of the Related Art

In a specimen testing system, a specimen transfer device for transferring a specimen container held in a rack to another rack can be disposed together with other units such as a specimen measurement unit and a smear sample preparation unit. For example, a smear sample may be required to be prepared only for a predetermined specimen as a result of specimens in a plurality of specimen containers held in a rack having been measured by the specimen measurement unit. In this case, the rack is transported to the specimen transfer device, and a specimen container containing a specimen from which a smear sample is to be prepared is temporarily held in a rack in the specimen transfer device. The specimen container held therein is transferred to an empty rack together with other specimen containers held in the rack in the specimen transfer device. Thereafter, the rack is moved to the smear sample preparation unit, and a smear sample of the specimen contained in each specimen container is prepared.

In this type of specimen testing system, time is required for processing of a specimen such as preparation of a smear sample and measurement of a specimen by another specimen measurement unit. Therefore, a rack waiting region in which a rack is caused to stay in a waiting state until end of processing for all of specimens held in a preceding rack is required. Japanese Laid-Open Patent Publication No. 2014-149162 discloses a specimen testing system including this type of specimen transfer device.

In the configuration disclosed in Japanese Laid-Open Patent Publication No. 2014-149162, a rack waiting region in which a rack is caused to stay in a waiting state until end of processing for all of specimens held in a preceding rack needs to be provided outside the specimen transfer device. Therefore, the rack waiting region increases an installation area of the specimen testing system.

### SUMMARY OF THE INVENTION

The scope of the present invention is defined solely by the appended claims, and is not affected to any degree by the statements within this summary.

A specimen transfer device (40, 70) of the present invention is directed to a specimen transfer device connected to a rack transportation path (1a) of a specimen testing system (1). The specimen transfer device (40, 70) of the present invention includes: an ascending/descending mechanism (42, 72) configured to move a rack (100) between a first ascending/descending position (P12, P22) at which the rack in a first tier (48, 78) is disposed, and a second ascending/descending position (P15, P25) at which the rack in a second tier (49, 79) is disposed; a container transfer mechanism (45, 74) configured to transfer a specimen container (110), to a second rack (120, 130, 100) disposed in the second tier (49, 79), from a first rack (100) moved by the ascending/descending mechanism (42, 72) from the first ascending/descending position to the second ascending/descending position; a rack waiting region (311, 431) disposed in the first tier (48, 78) and configured to cause the rack (100) to stay in a waiting state between the first ascending/descending position (P12, P22) and a carrying-out position (P13, P23) to the rack transportation path (1a); and a first transportation mechanism (303, 319 to 322, 423, 439 to 442) configured to transport the first rack (100) moved by the ascending/descending mechanism (42, 72) from the second ascending/descending position (P15, P25) to the first ascending/descending position (P12, P22), through the rack waiting region (311, 431), to the carrying-out position (P13, P23).

A specimen testing system (1) of the present invention includes: a specimen processing unit (52, 62) configured to process a specimen; a specimen rearrangement unit (40) configured to rearrange specimens; and a transportation unit (51, 61) including the rack transportation path (1a), the transportation unit (51, 61) configured to transport the first rack (100) between the specimen processing unit (52, 62) and the specimen rearrangement unit (40). The specimen rearrangement unit (40) has the same configuration as the above-described specimen transfer device.

A specimen testing system (1) of the present invention includes: a specimen processing unit (52, 62) configured to process a specimen; a specimen storage unit (70) configured to store specimens; and a transportation unit (11, 12, 13, 20, 31, 51, 61) including the rack transportation path (1a), the transportation unit (11, 12, 13, 20, 31, 51, 61) configured to transport the first rack (100) between the specimen processing unit (52, 62) and the specimen storage unit (70). The specimen storage unit (70) has the same configuration as the above-described specimen transfer device.

A specimen testing system (1) of the present invention includes: a specimen processing unit (52, 62) configured to process a specimen; a specimen rearrangement unit (40) configured to rearrange specimens; a specimen storage unit (70) configured to store specimens; and a transportation unit (11, 12, 13, 20, 31, 51, 61) including the rack transportation path (1a), the transportation unit (11, 12, 13, 20, 31, 51, 61) configured to transport the first rack (100) between the specimen rearrangement unit (40) and the specimen storage unit (70). The specimen rearrangement unit (40) and the specimen storage unit (70) each have the same configuration as the above-described specimen transfer device.

### BRIEF DESCRIPTION OF THE DRAWINGS

FIG. 1 schematically illustrates a configuration of a specimen testing system according to an embodiment;

FIG. 2 is a perspective view of structures of a rack and a container according to the embodiment;

FIG. 3 is a plan view schematically showing a configuration of a first tier of a specimen rearrangement unit according to the embodiment;

FIG. 4 is a plan view schematically showing a configuration of a second tier of the specimen rearrangement unit according to the embodiment;

FIG. 5 is a perspective view schematically showing an outer appearance of the specimen rearrangement unit according to the embodiment;

FIG. 6 is a plan view schematically showing a configuration of a first tier of a specimen storage unit according to the embodiment;

FIG. 7 is a plan view schematically showing a configuration of a second tier of the specimen storage unit according to the embodiment;

FIG. 8 is a perspective view schematically showing an outer appearance of the specimen storage unit according to the embodiment;

FIG. 9 is a perspective view of a configuration of an ascending/descending mechanism disposed in the specimen rearrangement unit according to the embodiment;

FIG. 10 is a perspective view of a configuration of an ascending/descending mechanism disposed in the specimen storage unit according to the embodiment;

FIG. 11 is a plan view schematically showing a configuration of a container transfer mechanism of the specimen rearrangement unit according to the embodiment;

FIG. 12 is a side view schematically showing configurations of an upward-downward moving portion and a holding portion according to the embodiment;

FIG. 13 is a block diagram illustrating a configuration of the specimen rearrangement unit according to the embodiment;

FIG. 14 is a block diagram illustrating a configuration of the specimen storage unit according to the embodiment;

FIG. 15 illustrates a transfer operation performed by the specimen rearrangement unit according to the embodiment;

FIG. 16 illustrates a transfer operation performed by the specimen storage unit according to the embodiment;

FIG. 17 schematically illustrates a path for transporting a rack between the specimen rearrangement unit and the specimen storage unit, according to the embodiment;

FIG. 18 schematically illustrates a configuration of a specimen testing system according to a modification 1;

FIG. 19 schematically illustrates a path for transporting a rack between a specimen rearrangement unit and a specimen storage unit, according to the modification 1;

FIG. 20 schematically illustrates a configuration of a specimen testing system according to a modification 2; and

FIG. 21 schematically illustrates a configuration of a specimen testing system according to a modification 3.

### DETAILED DESCRIPTION OF THE PREFERRED EMBODIMENTS

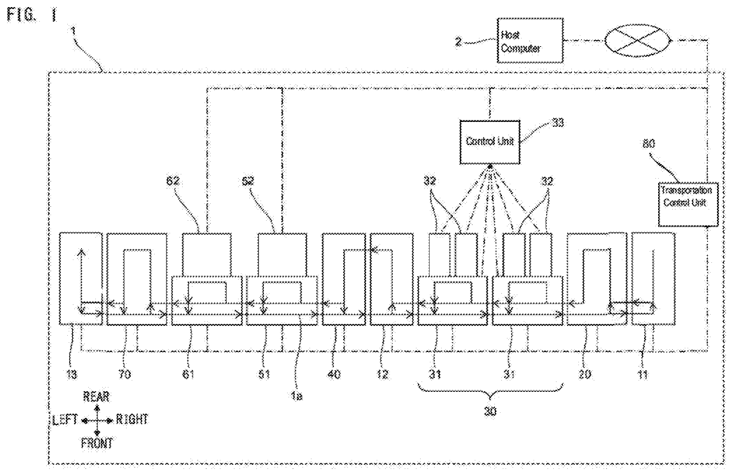

FIG. 1 schematically illustrates a configuration of a specimen testing system 1.

FIG. 1 illustrates the configuration of the specimen testing system 1 in a planar view, and indicates the front, the rear, the left, and the right directions in the planar view. The left direction represents the downstream-side direction and the succeeding-side direction, and the right direction represents the upstream-side direction and the preceding-side direction. An operator accesses the specimen testing system 1 from the front side of the specimen testing system 1. The front side of the specimen testing system 1 corresponds to the side in front of the operator.

The specimen testing system 1 includes a feeding unit 11, a transportation unit 12, a collection unit 13, a supply unit 20, a blood cell counting unit 30 for counting blood cells contained in a specimen, a specimen rearrangement unit 40, a transportation unit 51, a smear sample preparation unit 52, a transportation unit 61, an analyzer 62 for measuring measurement items such as CRP, HbA1c, and ESR, a specimen storage unit 70, and a transportation control unit 80. In the blood cell counting unit 30, one transportation unit 31 and two measurement units 32 form one set, and the blood cell counting unit 30 includes one control unit 33, and two sets each including the one transportation unit 31 and the two measurement units 32.

The control unit 33 is connected to the transportation units 31, the measurement units 32, and a host computer 2 so as to be able to communicate therewith. The smear sample preparation unit 52 is connected to the transportation unit 51 and the host computer 2 so as to be able to communicate therewith. The analyzer 62 is connected to the transportation unit 61 and the host computer 2 so as to be able to communicate therewith. The transportation control unit 80 is connected to the feeding unit 11, the transportation unit 12, the collection unit 13, the supply unit 20, the transportation units 31, the specimen rearrangement unit 40, the transportation units 51, 61, the specimen storage unit 70, and the host computer 2 so as to be able to communicate therewith. In FIG. 1, a communication cable for allowing communication among the units is indicated by an alternate long and short dash line.

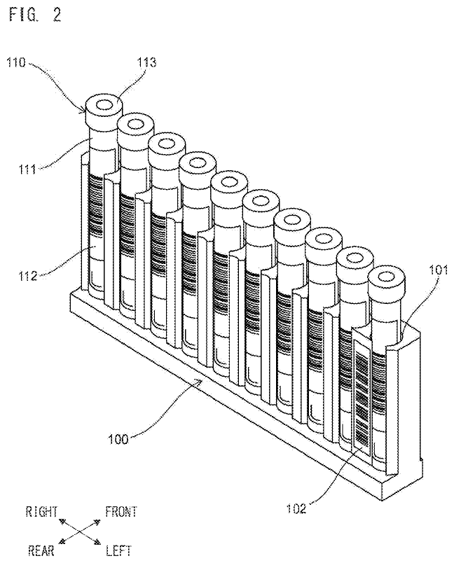

The specimen testing system 1 automatically measures a specimen, and performs analysis based on measurement data. A specimen is, for example, whole blood collected from a subject. A container 110 (see FIG. 2) containing the specimen is transported in a state where the container 110 is held in a rack 100, the specimen is suctioned from the container 110 by the measurement unit 32, the smear sample preparation unit 52, and the analyzer 62, and the specimen is, for example, measured. The transportation control unit 80 controls each of the units connected to the transportation control unit 80 so as to transport the rack 100 to a target unit.

FIG. 2 is a perspective view of structures of the rack 100 and the container 110.

The rack 100 has ten holes 101 in which the containers 110 can be held, and a bar code label 102. The bar code label 102 is adhered to a surface on the rear side of the rack 100. On the bar code label 102, a bar code indicating a rack ID is printed as identification information that allows individual identification of the rack 100.

The container 110 incudes a trunk portion 111, a bar code label 112, and a lid portion 113. The trunk portion 111 is formed as a tubular container having an opened upper end, and stores a specimen therein. The bar code label 112 is adhered to the side surface of the trunk portion 111. On the bar code label 112, a bar code indicating a specimen ID is printed as identification information that allows individual identification of the contained specimen. The lid portion 113 is disposed at the upper end of the trunk portion 111 so as to seal the inside of the trunk portion 111. The lid portion 113 is configured to allow piercers disposed at the measurement units 32, the smear sample preparation unit 52, and the analyzer 62 to penetrate therethrough in the up-down direction.

With reference to FIG. 1, in the specimen testing system 1, the feeding unit 11, the supply unit 20, the two transportation units 31, the transportation unit 12, the specimen rearrangement unit 40, the transportation unit 51, the transportation unit 61, the specimen storage unit 70, and the collection unit 13 are aligned in line toward the left direction in order, respectively, so as to be adjacent to each other. The rack 100 is transported mutually between the two adjacent units.

Each of the feeding unit 11, the supply unit 20, the transportation units 31, the transportation unit 12, the specimen rearrangement unit 40, the transportation units 51, 61, the specimen storage unit 70, and the collection unit 13 has a rack transportation path 1a for transporting the rack 100. The rack transportation path 1a is indicated by an arrow in FIG. 1, and the direction of the arrow indicates a direction in which the rack 100 can be transported in the rack transportation path 1a. The rack transportation paths 1a of the units are connected to each other at the front position of each unit. The rack transportation path 1a is formed of, for example, a conveyor belt that moves in the left-right direction, and a plate member having the upper surface parallel to the horizontal plane.

In the configuration illustrated in FIG. 1, an operator sets, in the rack 100, the containers 110 each of which contains a specimen to be tested, and sets the rack 100 in the feeding unit 11. Thus, the rack 100 is transported along the rack transportation path 1a, and the specimen is suctioned by a target unit according to a test item set for the specimen, thereby testing the specimen. When all of the necessary tests have ended, the rack 100 is collected by the collection unit 13.

With reference to FIG. 1, transportation of the rack 100 from the feeding unit 11 to the collection unit 13 will be described.

The feeding unit 11 carries out the rack 100 put by the operator to the supply unit 20.

The supply unit 20 reads the rack ID and the specimen IDs for the rack 100 carried in from the feeding unit 11, and carries out the rack 100 to the transportation unit 31 disposed adjacently on the left side.

The transportation unit 31 transports the rack 100 carried in from the unit that is disposed adjacently on the right side, to the front of the measurement unit 32. The measurement unit 32 suctions a specimen from the container 110 held in the transported rack 100, and counts blood cells in the specimen. The control unit 33 analyzes the specimen based on the measurement data obtained by each of the measurement units 32. The transportation unit 31 carries out the rack 100 to the unit disposed adjacently on the left side.

The transportation unit 12 transports rearward the rack 100 carried in from the transportation unit 31 that is disposed adjacently on the right side, and carries out the rack 100 to the specimen rearrangement unit 40 at a rear position.

In the specimen rearrangement unit 40, the container 110 to be processed by the succeeding specimen processing unit, that is, the smear sample preparation unit 52 and/or the analyzer 62, is transferred from the rack 100 carried in from the transportation unit 12, to an empty rack 100 held in the specimen rearrangement unit 40. The specimen rearrangement unit 40 transports forward the rack 100 that holds the transferred containers 110, and carries out the rack 100 to the transportation unit 51 disposed adjacently on the left side, at a front position. The specimen rearrangement unit 40 transports forward the rack 100 holding the containers 110 that are not required to be processed by the succeeding specimen processing unit and have not been transferred to the rack 100, and carries out the rack 100 to the transportation unit 51 disposed adjacently on the left side, at the front position. The rack 100 that has become empty by transfer of all of the containers 110 is held in the specimen rearrangement unit 40.

The transportation unit 51 transports the rack 100 holding the containers 110 to be processed by the smear sample preparation unit 52, among the racks 100 carried in from the specimen rearrangement unit 40 that is disposed adjacently on the right side, to the front of the smear sample preparation unit 52. The smear sample preparation unit 52 suctions a specimen from the container 110 held in the transported rack 100, and prepares a smear sample. The transportation unit 51 carries out the rack 100 that has been processed by the smear sample preparation unit 52 to the transportation unit 61 disposed adjacently on the left side. The transportation unit 51 does not transport the rack 100 that holds only the containers 110 for which smear samples are not required to be prepared by the smear sample preparation unit 52, to the front of the smear sample preparation unit 52, and carries out the rack 100 to the transportation unit 61 disposed adjacently on the left side.

The transportation unit 61 transports the rack 100 holding the containers 110 to be processed by the analyzer 62, among the racks 100 carried in from the transportation unit 51 that is disposed adjacently on the right side, to the front of the analyzer 62. The analyzer 62 is, for example, a unit capable of measuring measurement items such as CRP, HbA1c, and ESR. The analyzer 62 suctions a specimen from the container 110 held in the transported rack 100, and analyzes the specimen. The transportation unit 61 carries out the rack 100 that has been processed by the analyzer 62 to the specimen storage unit 70 disposed adjacently on the left side. The transportation unit 61 does not transport the rack 100 that holds only the containers 110 which do not require analysis by the analyzer 62, to the front of the analyzer 62, and carries out the rack 100 to the specimen storage unit 70 disposed adjacently on the left side.

The specimen storage unit 70 transports the rack 100 carried in from the transportation unit 61 that is disposed adjacently on the right side to an ascending/descending position P25 described below in the specimen storage unit 70, and transfers the containers 110 held in the rack 100 to an archive rack 130 described below in the specimen storage unit 70. The specimen storage unit 70 carries out the empty rack 100 to the transportation unit 61 disposed adjacently on the right side or the collection unit 13 disposed adjacently on the left side.

The collection unit 13 transports rearward the empty rack 100 carried in from the specimen storage unit 70 that is disposed adjacently on the right side and reserves the empty rack 100.

The transportation control unit 80 determines a destination to which the rack 100 is to be transported, and controls each unit that transports the rack 100 so as to transport the rack 100 to the determined destination.

The specimen testing system 1 is required to have a reduced installation area. Meanwhile, the specimen testing system 1 needs to cause the rack 100 that occurs in the specimen rearrangement unit 40 and the specimen storage unit 70 to stay in a waiting state until the rack 100 can be received by a unit on the downstream side. For example, in the present embodiment, a time required by the smear sample preparation unit 52 for preparing a smear sample is longer than a time required by the specimen rearrangement unit 40 for rearranging specimens. Therefore, if a region in which the rack 100 having specimens rearranged by the specimen rearrangement unit 40 is caused to stay in a waiting state is not provided, rearrangement of specimens cannot be started until preparation of a smear sample ends, and process efficiency of the specimen testing system 1 may be degraded. In order to avoid such a situation, an area for waiting is required. However, if such an area for waiting is separately disposed in the specimen testing system 1, the installation area of the specimen testing system 1 is increased.

Meanwhile, in this embodiment, the specimen rearrangement unit 40 and the specimen storage unit 70 each include a first tier and a second tier, and the first tier has a rack waiting region in which the rack 100 that occurs by transfer is caused to stay in a waiting state while the container 110 is transferred in the second tier. Thus, the installation area of the specimen testing system 1 can be effectively reduced.

The configurations of the specimen rearrangement unit 40 and the specimen storage unit 70 as described above will be described below.

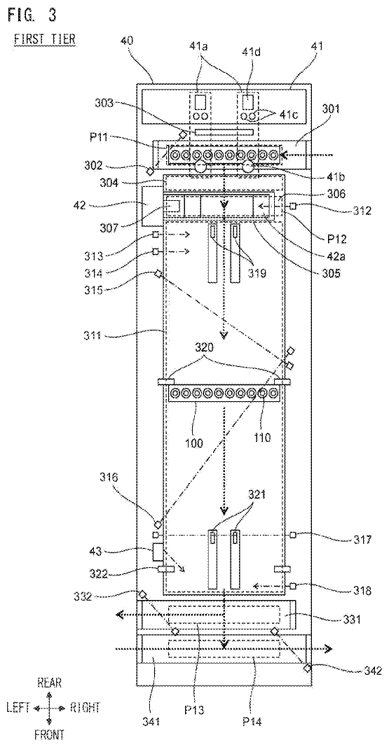

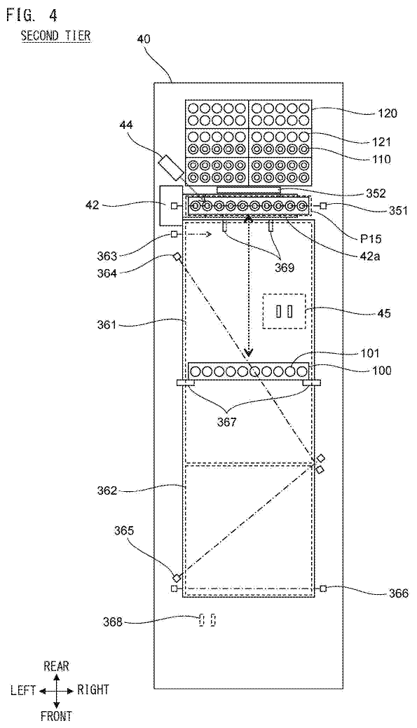

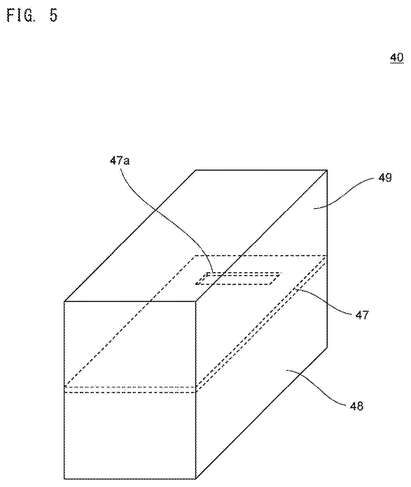

FIGS. 3 and 4 are each a plan view schematically showing a configuration of the specimen rearrangement unit 40 for rearranging specimens. FIGS. 3 and 4 show a first tier and a second tier, respectively, of the specimen rearrangement unit 40. FIG. 5 is a perspective view schematically showing an outer appearance of the specimen rearrangement unit 40. As shown in FIG. 5, the specimen rearrangement unit 40 has a two-tiered structure. The inner portion of the specimen rearrangement unit 40 is divided into two tiers, that is, upper and lower tiers, by a partition 47 that forms a bottom of the second tier and a ceiling of the first tier. The lower tier is a first tier 48 and the upper tier is a second tier 49. The first tier 48 and the second tier 49 overlap each other in a planar view. The partition 47 has an opening 47a that allows one rack 100 to pass therethrough. The partition 47 may have, for example, an opening or a cut portion other than the opening 47a. The first tier 48 and the second tier 49 may not necessarily be formed by the partition 47, and may be structured by disposing a casing of the second tier 49 on a casing of the first tier 48.

With reference to FIG. 3, in the first tier of the specimen rearrangement unit 40, a reading unit 41, an ascending/descending mechanism 42, a reader 43, a carrying-in path 301, a sensor 302, a transportation mechanism 303, an intermediate path 304, an opening 305, a connection portion 306, a relay portion 307, a rack waiting region 311, sensors 312 to 318, transportation mechanisms 319 to 322, a carrying-out path 331, a sensor 332, a carrying-out path 341, and a sensor 342 are provided.

The transportation unit 12 that is disposed adjacent to the specimen rearrangement unit 40 to the right thereof transports the rack 100 rearward and carries out the rack 100 to the specimen rearrangement unit 40 at the rear position.

The carrying-in path 301 extends in the left-right direction and is disposed on the rear side of the specimen rearrangement unit 40. The carrying-in path 301 is implemented by a conveyor belt that moves in the left-right direction, and transports leftward the rack 100 carried out from the transportation unit 12. The rack 100 is carried into the carrying-in path 301 in the longitudinal direction (the left-right direction) of the rack 100. The sensor 302 is a transmission-type photoelectric sensor, and detects the rack 100 positioned at a carrying-in position P11 on the carrying-in path 301. The reading unit 41 reads the rack ID and the specimen IDs from the rack 100 positioned at the carrying-in position P11.

The reading unit 41 includes two movable portions 41a that move in the left-right direction. Each movable portion 41a includes a driving roller 41b for rotating the container 110 held in the rack 100 in the circumferential direction, two driven rollers 41c for pressing the container 110 from the side opposite to the driving roller 41b side so as to allow the container 110 to be rotatable, and a reader 41d for reading the specimen ID from the container 110 held between the driving roller 41b and the driven rollers 41c. The container 110 is rotated in the hole 101 by the driving roller 41b around a rotation axis extending in the vertical direction, whereby the bar cord is assuredly read. The rack ID is read by the reader 41d on the left side. The reader 41d is a bar code reader.

The transportation mechanism 303 includes a member for pushing the side surface of the rack 100, transports the rack 100 disposed at the carrying-in position P11 in the transverse direction (front-rear direction) of the rack 100, and transports the rack 100 via the intermediate path 304 to an ascending/descending position P12 of the ascending/descending mechanism 42, and the rack waiting region 311.

The intermediate path 304, the connection portion 306, the relay portion 307, and the rack waiting region 311 are each formed of a plate member having the upper surface parallel to the horizontal plane. The intermediate path 304 and the rack waiting region 311 are connected to each other via the connection portion 306. The connection portion 306, the relay portion 307, and the ascending/descending position P12 of the ascending/descending mechanism 42 are disposed between the intermediate path 304 and the rack waiting region 311.

The intermediate path 304 is disposed between the carrying-in position P11 and the ascending/descending position P12 at which the rack 100 in the first tier is disposed. The width, in the front-rear direction, of the intermediate path 304 is almost equal to the width, in the front-rear direction (transverse direction), of one rack 100. That is, the ascending/descending position P12 is positioned forward of the carrying-in path 301 so as to be spaced therefrom over about a distance equivalent to the width, in the front-rear direction, of one rack 100.

The rack waiting region 311 is a region where the rack 100 stays in a waiting state when another rack 100 stays in the transportation unit 51 disposed adjacently on the left side or the transportation unit 12 disposed adjacently on the right side, and the rack 100 cannot be carried out from a carrying-out position P13 or a carrying-out position P14, and the rack waiting region 311 is also a movement path for moving the rack 100 from the ascending/descending position P12 to the carrying-out position P13. The rack waiting region 311 is a rectangular region having long sides along the front-rear direction, and extends forward from the ascending/descending position P12 in the front-rear direction. The rack waiting region 311 has such a length that twenty racks 100 are aligned in the rack transverse direction between the ascending/descending position P12 of the rack 100 in the first tier and the carrying-out position P13 to the rack transportation path 1a of a unit disposed on the left side.

The rack waiting region 311 may be at least a region in which the racks 100 can stay in a waiting state. From the viewpoint of reducing an area in which the specimen testing system 1 is installed, the number of the racks 100 that can stay in a waiting state in the region is preferably greater than or equal to 10, more preferably greater than or equal to 15, and even more preferably greater than or equal to 20. From the viewpoint of reducing a length, in the front-rear direction, of the specimen testing system 1, the number of the racks 100 that can stay in a waiting state in the rack waiting region 311 may be 50 or less and preferably may be 40 or less.

The ascending/descending mechanism 42 is disposed between the intermediate path 304 and the rack waiting region 311. The ascending/descending mechanism 42 moves the rack 100 positioned at the ascending/descending position P12 upward to the second tier. The transportation mechanism 303 places the rack 100 on the carrying-in path 301 at the ascending/descending position P12. The sensor 312 is a reflection-type photoelectric sensor, and detects the rack 100 positioned at the ascending/descending position P12.

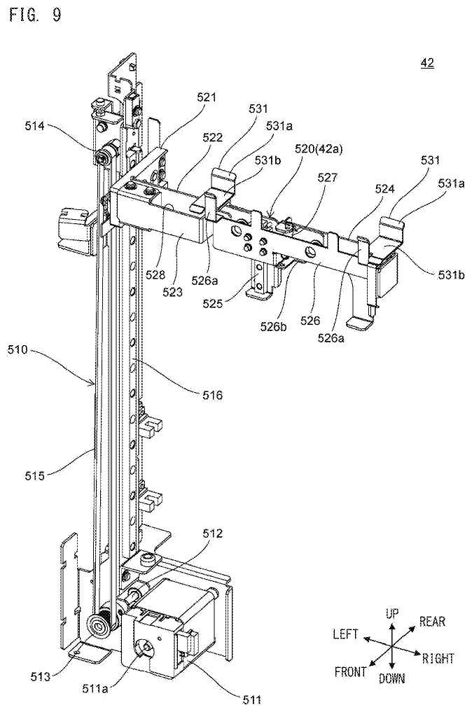

The opening 305 is formed between the intermediate path 304 and the rack waiting region 311. The opening 305 is a hole that penetrates in the up-down direction through the plate member forming the intermediate path 304, the connection portion 306, and the rack waiting region 311. The connection portion 306 is disposed to the right of the opening 305. The relay portion 307 is disposed at the left end in the opening 305. The lower surface of the rack 100 positioned at the ascending/descending position P12 is supported by the connection portion 306 and the relay portion 307. A support portion 42a of the ascending/descending mechanism 42 is disposed within the opening 305 in a planar view, and is shaped so as not to interfere with the connection portion 306 and the relay portion 307. The configuration of the ascending/descending mechanism 42 will be described below with reference to FIG. 9.

In a case where the rack 100 is moved upward from the first tier to the second tier, the ascending/descending mechanism 42 positions, in advance, the support portion 42a at a position lower than the rack waiting region 311. Thereafter, when the rack 100 has been transported to a position of the upper surface of each of the connection portion 306 and the relay portion 307, that is, the ascending/descending position P12, the ascending/descending mechanism 42 moves the support portion 42a upward to place the rack 100 on the upper surface of the support portion 42a and moves the rack 100 upward to the second tier. As described below, in the second tier, the containers 110 held in the rack 100 are rearranged. When the rearrangement of the containers 110 has ended, the ascending/descending mechanism 42 moves the support portion 42a downward, and positions the support portion 42a at a position lower than the rack waiting region 311. Thus, the rack 100 is positioned at the position of the upper surface of each of the connection portion 306 and the relay portion 307, that is, at the ascending/descending position P12.

The rack 100 positioned at the ascending/descending position P12 is transported along the rack waiting region 311 toward the front of the specimen rearrangement unit 40 in the transverse direction (front-rear direction) of the rack 100. The rack 100 returned to the ascending/descending position P12 is transported forward of the ascending/descending position P12 by the transportation mechanism 303. The rack 100 having the containers that are not required to be rearranged is not moved to the second tier and is transported forward of the ascending/descending position P12 after the rack 100 is positioned at the ascending/descending position P12.

In a case where, when the reading unit 41 ends reading of the rack 100 at the carrying-in position P11, no rack 100 is at the ascending/descending position P12 and no rack 100 is being moved upward to the second tier by the ascending/descending mechanism 42, the transportation mechanism 303 positions the rack 100 positioned at the carrying-in position P11, at the ascending/descending position P12. In a case where, when the reading unit 41 ends reading of the rack 100 at the carrying-in position P11, the rack 100 returned from the second tier or the rack 100 that is not required to be moved upward to the second tier is positioned at the ascending/descending position P12, the transportation mechanism 303 pushes out the rack 100 positioned at the carrying-in position P11 forward, and thus collectively transports forward the rack 100 at the carrying-in position P11 and the rack 100 at the ascending/descending position P12. Thus, the rack 100 positioned at the carrying-in position P11 is positioned at the ascending/descending position P12, and the rack 100 positioned at the ascending/descending position P12 is transported forward of the ascending/descending position P12.

In a case where, when the reading unit 41 ends reading of the rack 100 positioned at the carrying-in position P11, the rack 100 positioned at the carrying-in position P11 is not required to be moved upward to the second tier and another rack 100 is being moved upward to the second tier by the ascending/descending mechanism 42, the transportation mechanism 303 may transport the rack 100 positioned at the carrying-in position P11, forward of the ascending/descending position P12, through the ascending/descending position P12.

The sensors 313 to 318 each detect the rack 100 on the rack waiting region 311. A state of the racks 100 staying on the rack waiting region 311 is detected based on detection signals of the sensors 313 to 318. The sensors 313, 314, and 318 are reflection-type photoelectric sensors, and the sensors 315 to 317 are transmission-type photoelectric sensors.

The transportation mechanisms 319 to 322 move the rack 100 transported forward of the ascending/descending position P12 by the transportation mechanism 303, along the rack waiting region 311, in the transverse direction (front-rear direction) of the rack 100, and transport the rack 100 to the carrying-out position P13, P14. At this time, the rack 100 on the carrying-out position P13 is caused to stay in a waiting state at the carrying-out position P13 as appropriate according to a processing state on the succeeding side. The rack 100 on the carrying-out position P14 is caused to stay in a waiting state at the carrying-out position P14 as appropriate according to a processing state on the preceding side.

The transportation mechanism 319 has a member that protrudes upward from the upper surface of the rack waiting region 311 and pushes the lower portion of the rack 100, and further transports forward the rack 100 transported forward of the ascending/descending position P12. The transportation mechanism 320 includes a pair of members for pushing the side surface of the rack 100, and further transports forward the rack 100 transported forward by the transportation mechanism 319. The transportation mechanism 321 has the same configuration as the transportation mechanism 319, and further transports forward the rack 100 transported forward by the transportation mechanism 320. The transportation mechanism 322 has the same configuration as the transportation mechanism 320, and transports the rack 100 transported forward by the transportation mechanism 321 to the carrying-out path 331 or the carrying-out path 341. The reader 43 reads the rack ID of the rack 100 positioned near the front end of the rack waiting region 311. The reader 43 is a bar code reader.

The carrying-out path 331 is implemented by a conveyor belt that moves in the left-right direction, and carries out the rack 100 carried out from the rack waiting region 311 to the transportation unit 51 disposed adjacently on the left side. The sensor 332 is a transmission-type photoelectric sensor, and detects the rack 100 positioned at the carrying-out position P13 on the carrying-out path 331. The carrying-out path 341 is implemented by a conveyor belt that moves in the left-right direction, and carries out the rack 100 that is carried out from the transportation unit 51 disposed adjacently on the left side, and the rack 100 carried out through the carrying-out path 331 from the rack waiting region 311, to the transportation unit 12 disposed adjacently on the right side. The sensor 342 is a transmission-type photoelectric sensor, and detects the rack 100 positioned at the carrying-out position P14 on the carrying-out path 341.

With reference to FIG. 4, in the second tier of the specimen rearrangement unit 40, a reader 44, a container transfer mechanism 45, a sensor 351, a transportation mechanism 352, a rack reserving section 361, a rack setting section 362, sensors 363 to 366, a transportation mechanism 367, a sensor 368, a stopper 369, and a buffer rack 120 are provided.

The ascending/descending mechanism 42 positions the rack 100 moved upward from the ascending/descending position P12 in the first tier, at an ascending/descending position P15 at which the rack 100 in the second tier is disposed. The sensor 351 is a transmission-type photoelectric sensor, and detects the rack 100 positioned at the ascending/descending position P15. The reader 44 reads the rack ID of the rack 100 positioned at the ascending/descending position P15. The reader 44 is a bar code reader.

The container transfer mechanism 45 can transfer the container 110 between the rack 100 and the buffer rack 120. The container transfer mechanism 45 transfers the container 110, to the buffer rack 120 disposed in the second tier, from the rack 100 moved by the ascending/descending mechanism 42 from the ascending/descending position P12 in the first tier to the ascending/descending position P15 in the second tier. The container transfer mechanism 45 rearranges the containers 110 by using the buffer rack 120 such that the rack 100 holds only the containers 110 containing specimens to be processed by the succeeding units (the smear sample preparation unit 52 and the analyzer 62) or only the containers 110 containing specimens that are not required to be processed by the succeeding units. When the rearrangement of the containers 110 has ended, the ascending/descending mechanism 42 moves the rack 100 positioned at the ascending/descending position P15 downward to the first tier, and positions the rack 100 at the ascending/descending position P12.

The transportation mechanism 352 includes a member for pushing the side surface of the rack 100, and transports the rack 100 positioned at the ascending/descending position P15 to the rack reserving section 361. In a case where all of the containers 110 have been transferred to the buffer rack 120 from the rack 100 positioned at the ascending/descending position P15, the rack 100 becomes the rack 100 (hereinafter, referred to as “empty rack”) that does not hold the containers 110. In this case, the transportation mechanism 352 transports the empty rack that has become empty at the ascending/descending position P15 to the rack reserving section 361.

The rack reserving section 361 and the rack setting section 362 are formed as a rear-side portion and a front-side portion, respectively, of a plate member having the upper surface parallel to the horizontal plane. The plate member of the rack reserving section 361 and the rack setting section 362 extends from the rear side to the front side in the front-rear direction. The upper portion of the rack setting section 362 is opened outward through an opening formed in the casing of the specimen rearrangement unit 40.

The sensors 363, 364 detect the rack 100 on the rack reserving section 361. A state of an empty rack reserved on the rack reserving section 361 is detected based on detection signals of the sensors 363, 364. The sensor 363 is a reflection-type photoelectric sensor, and the sensor 364 is a transmission-type photoelectric sensor. The sensors 365, 366 detect the rack 100 on the rack setting section 362. A state of an empty rack set on the rack setting section 362 is detected based on detection signals of the sensors 365, 366. The sensors 365, 366 are transmission-type photoelectric sensors.

The transportation mechanism 367 includes a pair of members for pushing the side surface of the rack 100, and transports the rack 100 on the rack reserving section 361 and the rack setting section 362 in the front-rear direction. The sensor 368 is a transmission-type photoelectric sensor, and detects that the transportation mechanism 367 is positioned at an originating position. When the transportation mechanism 367 moves a movement portion of the transportation mechanism 367 to the forefront position, the movement portion is positioned at the sensor 368. The sensor 368 detects that the transportation mechanism 367 is positioned at the originating position by detecting the movement portion.

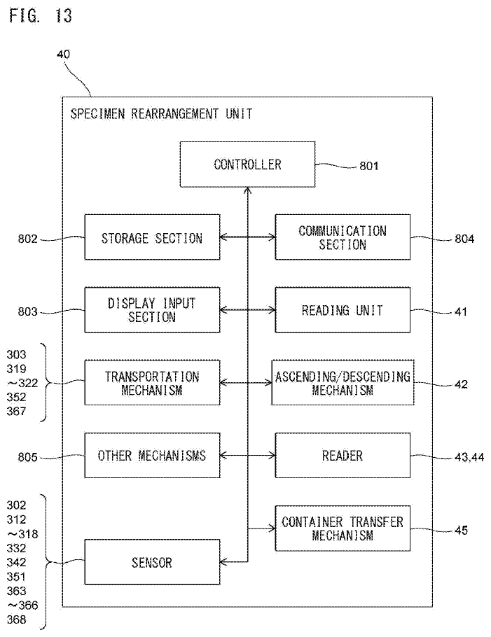

The buffer rack 120 has a plurality of holes 121 in which the containers 110 containing specimens can be held. In the buffer rack 120 in FIG. 4, sixty holes 121 in total are formed in a grid-like shape such that six rows of the holes 121 are formed in the front-rear direction and ten lines of the holes 121 are formed in the left-right direction. In a case where a predetermined number N of the containers 110 are held in the buffer rack 120, or in a case where a predetermined time T elapses from a time when the first specimen has been stored in the buffer rack 120, the containers 110 are transferred from the buffer rack 120 to the rack 100 positioned at the ascending/descending position P15 such that only the containers 110 to be transported to the same destination are held in the rack 100. The predetermined number N can be, for example, set in a range of one to ten through a display input section 803 (see FIG. 13). The predetermined time T can be, for example, set in a range of one minute to 30 minutes through the display input section 803.

In a case where, when the container is transferred from the buffer rack 120 to the rack 100, the rack 100 to which the container is to be transferred is not at the ascending/descending position P15, the transportation mechanism 367 pushes the front surface of an empty rack on the forefront side among empty racks reserved in the rack reserving section 361 and the rack setting section 362, and pushes out a rearmost empty rack among the empty racks reserved in the rack reserving section 361 and the rack setting section 362 to the ascending/descending position P15. At this time, since the stopper 369 protrudes upward from the upper surface of the rack reserving section 361, the rearmost empty rack and an empty rack that is disposed adjacent to and forward of the rearmost empty rack are separated. Thereafter, the container 110 is transferred from the buffer rack 120 to the empty rack positioned at the ascending/descending position P15 by the container transfer mechanism 45.

When the transfer of the containers 110 to the rack 100 positioned at the ascending/descending position P15 has ended, the rack 100 is moved to the ascending/descending position P12 in the first tier by the ascending/descending mechanism 42, and carried out to the transportation unit 51 disposed adjacently on the left side or the transportation unit 12 disposed adjacently on the right side.

When the number of empty racks reserved in the rack reserving section 361 becomes less than or equal to a predetermined number, the transportation control unit 80 controls each unit so as to transport the rack 100 that has become empty since all of the containers 110 have been taken out by the specimen storage unit 70, through the transportation unit 12, to the specimen rearrangement unit 40. The specimen rearrangement unit 40 transports the empty rack carried in from the transportation unit 12 to the rack reserving section 361 in the second tier.

An operator may set empty racks in the rack setting section 362 at which the upper portion is opened outward, with reference to notification on the display input section 803 (see FIG. 13) indicating that the empty racks are insufficient. The transportation mechanism 367 transports the empty racks that have been set in the rack setting section 362 by the operator, to the rack reserving section 361 and the ascending/descending position P15 as appropriate.

The number of the empty racks reserved in the rack reserving section 361 and the rack setting section 362 is detected according to the number of steps of a stepping motor which is counted until return to the originating position detected by the sensor 368 from a drive position for positioning the empty rack at the ascending/descending position P15 when the transportation mechanism 367 transports the empty rack to the ascending/descending position P15. The number of steps of the stepping motor is counted by a rotary encoder or the like.

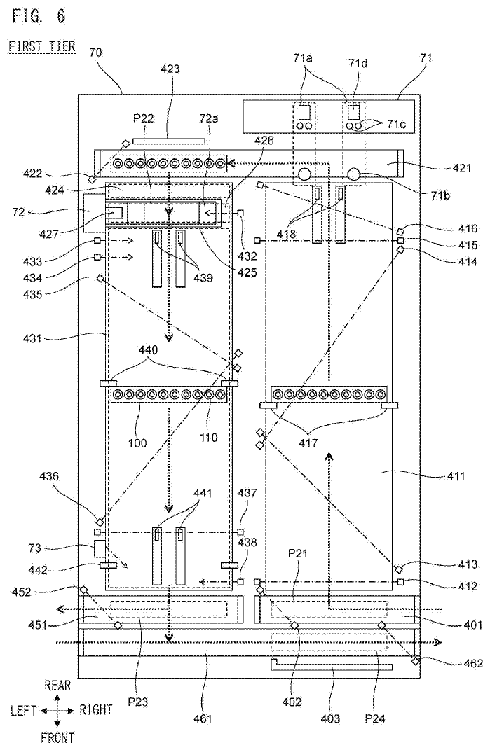

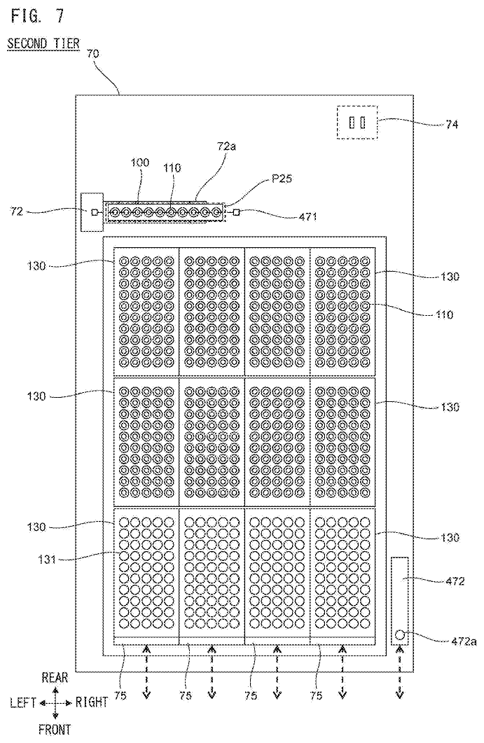

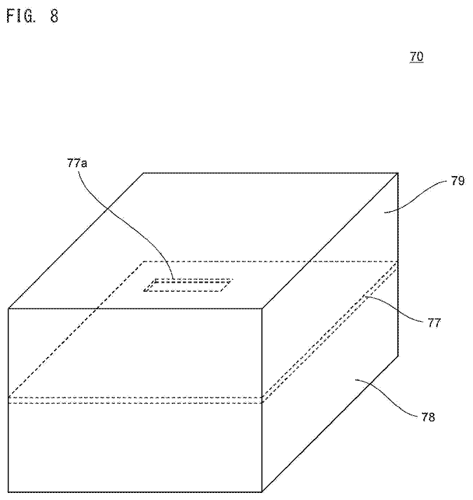

FIGS. 6 and 7 are each a plan view schematically showing a configuration of the specimen storage unit 70 for storing specimens. FIGS. 6 and 7 show the first tier and the second tier, respectively, of the specimen storage unit 70. FIG. 8 is a perspective view schematically showing an outer appearance of the specimen storage unit 70. As shown in FIG. 8, the specimen storage unit 70 has a two-tiered structure similarly to the specimen rearrangement unit 40. The inner portion of the specimen storage unit 70 is divided into two tiers, that is, upper and lower tiers, by a partition 77 that forms a bottom of the second tier and a ceiling of the first tier. The lower tier is a first tier 78 and the upper tier is a second tier 79. The first tier 78 and the second tier 79 overlap each other in a planar view. The partition 77 has an opening 77a that allows one rack 100 to pass therethrough. The partition 77 may have, for example, an opening or a cut portion other than the opening 77a. The first tier 78 and the second tier 79 may not necessarily be formed by the partition 77 and may be structured by disposing a casing of the second tier 79 on a casing of the first tier 78.

With reference to FIG. 6, in the first tier of the specimen storage unit 70, a reading unit 71, an ascending/descending mechanism 72, a reader 73, a carrying-in path 401, a sensor 402, a transportation mechanism 403, a movement path 411, sensors 412 to 416, transportation mechanisms 417, 418, a carrying-in path 421, a sensor 422, a transportation mechanism 423, an intermediate path 424, an opening 425, a connection portion 426, a relay portion 427, a rack waiting region 431, sensors 432 to 438, transportation mechanisms 439 to 442, a carrying-out path 451, a sensor 452, a carrying-out path 461, and a sensor 462 are provided.

The transportation unit 61 that is disposed adjacent to the specimen storage unit 70 to the right thereof carries out the rack 100, along the rack transportation path 1a (see FIG. 1) disposed on the front side, to the specimen storage unit 70, at a front position.

The carrying-in path 401 is implemented by a conveyor belt that moves in the left-right direction, and transports leftward the rack 100 carried out from the transportation unit 61. The sensor 402 is a transmission-type photoelectric sensor, and detects the rack 100 positioned at a carrying-in position P21 on the carrying-in path 401. The transportation mechanism 403 includes a member for pushing the side surface of the rack 100, and transports the rack 100 positioned at the carrying-in position P21 to the movement path 411.

The movement path 411 is formed by a plate member having the upper surface parallel to the horizontal plane, and extends from the front side to the rear side of the specimen storage unit 70 in the front-rear direction. The sensors 412 to 416 detect the rack 100 on the movement path 411. A state of the rack 100 staying on the movement path 411 is detected based on detection signals of the sensors 412 to 416. The sensors 412 to 416 are transmission-type photoelectric sensors.

The transportation mechanisms 417 and 418 move the rack 100 along the movement path 411 in the transverse direction (front-rear direction) of the rack 100, and transport the rack 100 to the carrying-in path 421. The transportation mechanism 417 includes a pair of members for pushing the side surface of the rack 100, and moves the rack 100 on the movement path 411 to the position of the sensor 415. The transportation mechanism 418 includes a member that protrudes upward from the upper surface of the movement path 411 and pushes the lower portion of the rack 100, and transports the rack 100 positioned at the sensor 415 to the right end of the carrying-in path 421.

The reading unit 71 reads the rack ID and the specimen IDs from the rack 100 positioned at the right end of the carrying-in path 421. The reading unit 71 has a configuration similar to the configuration of the reading unit 41 in FIG. 3. The reading unit 71 includes two movable portions 71a, and each movable portion 71a includes a driving roller 71b, two driven rollers 71c, and a reader 71d. The reader 71d is a bar code reader.

The carrying-in path 421 extends in the left-right direction and is disposed on the rear side of the specimen storage unit 70. The carrying-in path 421 is implemented by a conveyor belt that moves in the left-right direction, and moves leftward the rack 100 transported from the movement path 411. The sensor 422 is a transmission-type photoelectric sensor and detects the rack 100 positioned at the left end of the carrying-in path 421. The transportation mechanism 423 includes a member for pushing the side surface of the rack 100, and transports the rack 100 disposed at the left end of the carrying-in path 421 through the intermediate path 424 to the rack waiting region 431.

The intermediate path 424, the opening 425, the connection portion 426, the relay portion 427, the rack waiting region 431, the sensors 432 to 438, the transportation mechanisms 439 to 442, the ascending/descending mechanism 72, and the reader 73 have configurations similar to the configurations of the intermediate path 304, the opening 305, the connection portion 306, the relay portion 307, the rack waiting region 311, the sensors 312 to 318, the transportation mechanisms 319 to 322, the ascending/descending mechanism 42, and the reader 43, respectively, in FIG. 3. The width, in the front-rear direction, of the intermediate path 424 is almost equal to the width, in the front-rear direction (transverse direction), of one rack 100.

The rack waiting region 431 is a region where the rack 100 stays in a waiting state when another rack 100 stays in the collection unit 13 disposed adjacently on the left side or the transportation unit 61 disposed adjacently on the right side, and the rack 100 cannot be carried out from a carrying-out position P23 or a carrying-out position P24, and the rack waiting region 431 is also a movement path for moving the rack 100 from an ascending/descending position P22 to the carrying-out position P23. The rack waiting region 431 is a rectangular region having long sides along the front-rear direction, and extends forward from the ascending/descending position P22 at which the rack 100 in the first tier is disposed, in the front-rear direction. The rack waiting region 431 has such a length that twenty racks 100 are aligned in the rack transverse direction between the ascending/descending position P22 of the rack 100 in the first tier and the carrying-out position P23 to the rack transportation path 1a of a unit disposed on the left side

The rack waiting region 431 may be at least a region in which the racks 100 can stay in a waiting state. From the viewpoint of reducing an area in which the specimen testing system 1 is installed, the number of the racks 100 that can stay in a waiting state in the region is preferably greater than or equal to 10, more preferably greater than or equal to 15, and even more preferably greater than or equal to 20. From the viewpoint of reducing the length, in the front-rear direction, of the specimen testing system 1, the number of the racks 100 that can stay in a waiting state in the rack waiting region 431 may be 50 or less and preferably may be 40 or less.

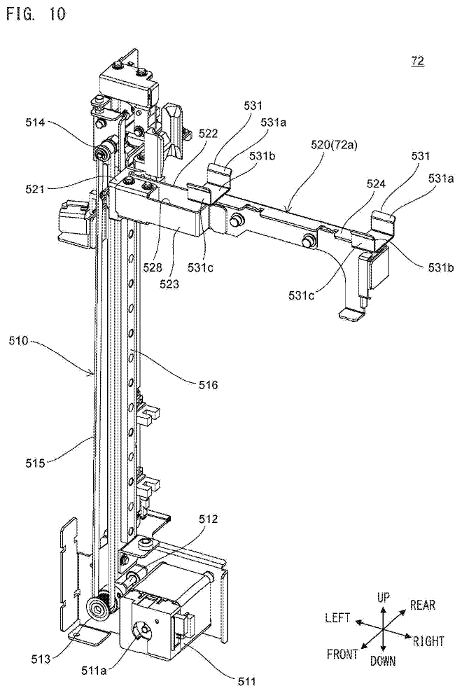

The ascending/descending mechanism 72 moves the rack 100 in the up-down direction by moving a support portion 72a that supports the lower surface of the rack 100, in the up-down direction. The configuration of the ascending/descending mechanism 72 will be described below with reference to FIG. 10.

The rack 100 carried out from the carrying-in path 421 is positioned at the ascending/descending position P22 through the intermediate path 424, and the rack 100 positioned at the ascending/descending position P22 is moved to the second tier by the ascending/descending mechanism 72. In the second tier, as described below, the containers 110 held in the rack 100 are taken out from the rack 100 and stored. Thus, the rack 100 moved to the second tier becomes an empty rack. When the storage of the containers 110 has ended, the ascending/descending mechanism 72 moves the rack 100 positioned in the second tier downward to the first tier, and positions again the rack 100 at the ascending/descending position P22.

The rack 100 positioned at the ascending/descending position P22 is transported toward the front side of the specimen storage unit 70 along the rack waiting region 431 in the transverse direction (front-rear direction) of the rack 100. The rack 100 returned to the ascending/descending position P22 is transported forward of the ascending/descending position P22 by the transportation mechanism 423.

In a case where, when the rack 100 has arrived at the left end of the carrying-in path 421, no rack 100 is at the ascending/descending position P22 and no rack 100 is being moved upward to the second tier by the ascending/descending mechanism 72, the transportation mechanism 423 positions the rack 100 positioned at the left end of the carrying-in path 421, at the ascending/descending position P22. In a case where, when the rack 100 has arrived at the left end of the carrying-in path 421, the rack 100 returned from the second tier to the ascending/descending position P22 or the rack 100 that is not required to be moved upward to the second tier is positioned, the transportation mechanism 423 pushes out the rack 100 positioned at the left end of the carrying-in path 421 forward and thus collectively transports forward the rack 100 positioned at the left end of the carrying-in path 421 and the rack 100 positioned at the ascending/descending position P22. Thus, the rack 100 positioned at the left end of the carrying-in path 421 is positioned at the ascending/descending position P22, and the rack 100 positioned at the ascending/descending position P22 is transported forward of the ascending/descending position P22.

The transportation mechanisms 439 to 442 move an empty rack transported forward of the ascending/descending position P22 by the transportation mechanism 423, along the rack waiting region 431, in the transverse direction (front-rear direction) of the rack 100, and transport the empty rack to the carrying-out position P23, P24. At this time, the rack 100 on the carrying-out position P23 is caused to stay in a waiting state at the carrying-out position P23 as appropriate according to a processing state on the succeeding side. The rack 100 on the carrying-out position P24 is caused to stay in a waiting state at the carrying-out position P24 as appropriate according to a processing state on the preceding side. The reader 73 reads the rack ID from the rack 100 positioned near the front end of the rack waiting region 431. The reader 73 is a bar code reader.

The carrying-out path 451 is implemented by a conveyor belt that moves in the left-right direction, and carries out the rack 100 carried out from the rack waiting region 431 to the collection unit 13 disposed adjacently on the left side. The sensor 452 is a transmission-type photoelectric sensor, and detects the rack 100 positioned at the carrying-out position P23 on the carrying-out path 451. The carrying-out path 461 is implemented by a conveyor belt that moves in the left-right direction, and carries out the rack 100 carried out from the collection unit 13 disposed adjacently on the left side and the rack 100 carried out from the rack waiting region 431 through the carrying-out path 451, to the transportation unit 61 disposed adjacently on the right side. The sensor 462 is a transmission-type photoelectric sensor, and detects the rack 100 positioned at the carrying-out position P24 at the right end of the carrying-out path 461. The transportation mechanism 403 can also transport the rack 100 positioned at the carrying-out position P24 to the movement path 411.

With reference to FIG. 7, in the second tier of the specimen storage unit 70, a container transfer mechanism 74, a tray 75, the archive rack 130, a sensor 471, and a take-out section 472 are provided.

The ascending/descending mechanism 72 positions the rack 100 moved upward from the ascending/descending position P22 in the first tier, at the ascending/descending position P25 at which the rack 100 in the second tier is disposed. The sensor 471 is a transmission-type photoelectric sensor and detects the rack 100 positioned at the ascending/descending position P25.

The container transfer mechanism 74 can transfer the container 110 between the rack 100 and the archive rack 130. The container transfer mechanism 74 transfers the container 110, from the rack 100 moved from the first tier to the second tier by the ascending/descending mechanism 72, to the archive rack 130 disposed in the second tier. The container transfer mechanism 74 takes out all of the containers 110 from the rack 100 positioned at the ascending/descending position P25, and stores the taken-out containers 110 in the archive rack 130. When all of the containers 110 have been taken out from the rack 100, the ascending/descending mechanism 72 moves the rack 100 that has become empty to the ascending/descending position P22 in the first tier. The empty rack returned to the first tier is transported to the collection unit 13 or the specimen rearrangement unit 40.

The archive rack 130 is detachably set to the tray 75 that can be drawn forward of the specimen storage unit 70. The archive rack 130 has a plurality of holes 131 in which the containers 110 containing specimens can be held. In the archive rack 130 in FIG. 7, fifty holes 131 in total are formed in a grid-like shape such that ten rows of the holes 131 are formed in the front-rear direction, and five lines of the holes 131 are formed in the left-right direction. In FIG. 7, four trays 75 are disposed in the left-right direction, and one tray 75 can hold three archive racks 130 aligned in the front-rear direction. When the operator inputs an instruction for taking out the tray 75, the target tray 75 is unlocked. Thus, the operator is allowed to draw the target tray 75 forward and take out the target archive rack 130.

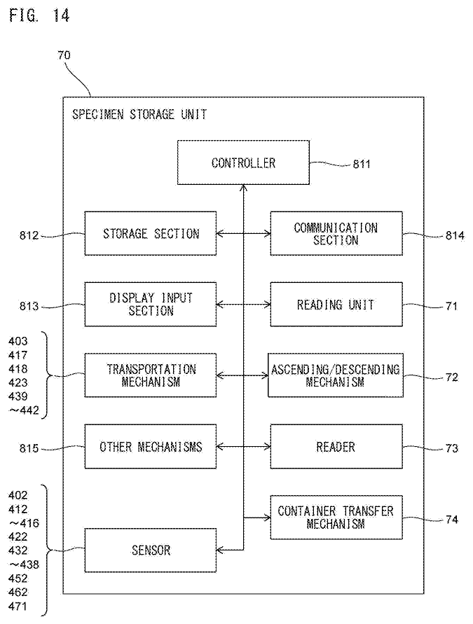

The take-out section 472 can be drawn forward of the specimen storage unit 70. The take-out section 472 has a hole 472a in which the container 110 can be held. The container transfer mechanism 74 can transfer the container 110 between the archive rack 130 and the take-out section 472. When the operator inputs an instruction for taking out a predetermined container 110 through a display input section 813 (see FIG. 14), the container transfer mechanism 74 transfers the target container 110 from the archive rack 130 to the take-out section 472, and the take-out section 472 is pushed forward. Thus, the operator is allowed to take out the target container 110 from the take-out section 472.

FIG. 9 is a perspective view of a configuration of the ascending/descending mechanism 42 disposed in the specimen rearrangement unit 40.

The ascending/descending mechanism 42 includes an upward-downward moving portion 510 and a support portion 520. The upward-downward moving portion 510 moves the support portion 520 in the up-down direction. The support portion 42a (see FIG. 3) of the ascending/descending mechanism 42 is implemented by the support portion 520.

The upward-downward moving portion 510 includes a motor 511, pulleys 513, 514, a belt 515, and a rail 516.

The motor 511 is implemented by a stepping motor. The motor 511 has a rotation shaft 511a extending in the front-rear direction. The pulley 513 is connected to the rotation shaft 511a via a shaft, a belt, or the like so as to rotate around the center axis extending in the front-rear direction in conjunction with the rotation shaft 511a of the motor 511. The pulley 514 is disposed above the pulley 513. The belt 515 is connected to the pulleys 513, 514, and is moved in the up-down direction according to driving of the motor 511. The rail 516 extends in the up-down direction.

The support portion 520 includes a connection member 521, base members 522, 523, 524, a rail 525, a movable member 526, a spring 527, and two support members 531.

The connection member 521 is fixed to the belt 515. When the belt 515 is moved in the up-down direction, the connection member 521 is moved in the up-down direction while being supported by the rail 516. The base members 522 and 523 are disposed at the connection member 521 so as to be spaced over a gap 528 in the front-rear direction. The base member 524 is fixed to the base member 522 so as to extend rightward from the base member 522. The rail 525 is disposed on the front face of the base member 522 so as to extend in the up-down direction.

The movable member 526 is disposed at the rail 525 so as to be movable along the rail 525 in the up-down direction. One end of the spring 527 is connected to the base member 522, and the other end of the spring 527 is connected to the movable member 526. In a normal state, the movable member 526 is urged by the spring 527 so as to be positioned at the upper end of the rail 525. At the upper left end and the upper right end of the movable member 526, surfaces 526a are formed so as to be parallel in the up-down and the left-right directions.

The two support members 531 are disposed at the upper left end and the upper right end of the base member 524. The support members 531 have surfaces 531a parallel in the up-down and the left-right directions, and surfaces 531b parallel in the front-rear and the left-right directions.

By driving the motor 511 of the upward-downward moving portion 510, the support portion 520 is moved in the up-down direction. When the support portion 520 is moved in the up-down direction in the first tier, the relay portion 307 in FIG. 3 passes through the gap 528 between the base members 522 and 523. Thus, contact between the support portion 520 and the relay portion 307 is avoided.

When the rack 100 is moved upward by the ascending/descending mechanism 42, the rack 100 is positioned between the surface 531a of the support member 531 and the surface 526a of the movable member 526. At this time, rearward movement of the rack 100 is restricted by a pair of the surfaces 531a, and forward movement of the rack 100 is regulated by a pair of the surfaces 526a. Thus, the rack 100 can be prevented from being moved in the front-rear direction during ascending/descending.

As described with reference to FIG. 4, the rack reserving section 361 is disposed forward of the ascending/descending position P15 in the second tier of the specimen rearrangement unit 40, and the rack 100 is transported between the ascending/descending position P15 and the rear end of the rack reserving section 361. In this case, the movable member 526 is moved downward, and the surface 526a is withdrawn downward of the surface 531b of the support member 531. Specifically, when the support portion 520 is moved upward, an upper surface of a flange 526b of the movable member 526 comes into contact with a predetermined member disposed in the second tier of the specimen rearrangement unit 40. Thus, the support member 531 is positioned at the ascending/descending position P15 in the second tier, and the surface 526a is thus automatically withdrawn downward, so that the rack 100 can be transported between the ascending/descending position P15 and the rear end of the rack reserving section 361.

FIG. 10 is a perspective view of a configuration of the ascending/descending mechanism 72 disposed in the specimen storage unit 70.

The ascending/descending mechanism 72 has almost the same configuration as the ascending/descending mechanism 42 in FIG. 9. In FIG. 10, the same components as those of the ascending/descending mechanism 42 in FIG. 9 are denoted by the same reference characters as those in FIG. 9 for convenience sake. The ascending/descending mechanism 72 does not have the rail 525, the movable member 526, and the spring 527 as compared with the ascending/descending mechanism 42 in FIG. 9. Surfaces 531c are formed on the front side of the support members 531 so as to be parallel in the up-down and the left-right directions, as compared with the ascending/descending mechanism 42 in FIG. 9. The support portion 72a (see FIG. 6) of the ascending/descending mechanism 72 is implemented by the support portion 520.

The rack 100 positioned at the ascending/descending position P25 in the second tier by the ascending/descending mechanism 72 is not transported in the second tier, unlike in the specimen rearrangement unit 40. Therefore, the ascending/descending mechanism 72 does not have the rail 525, the movable member 526, and the spring 527. In the support member 531, the surface 531c is formed also on the front side in addition to the surface 531a on the rear side. Thus, the rack 100 supported by the support member 531 can be prevented from being moved in the front-rear direction.

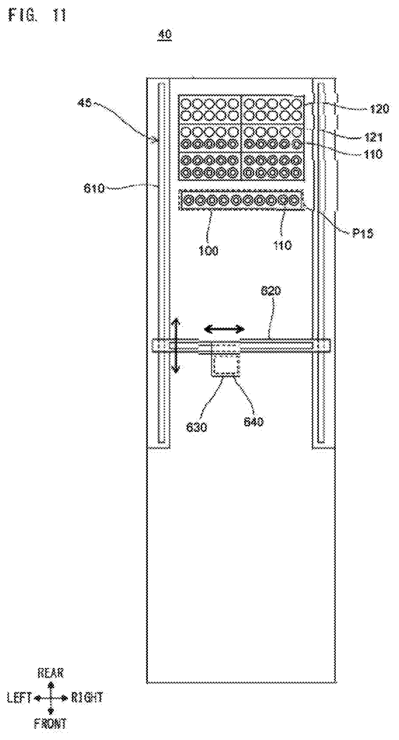

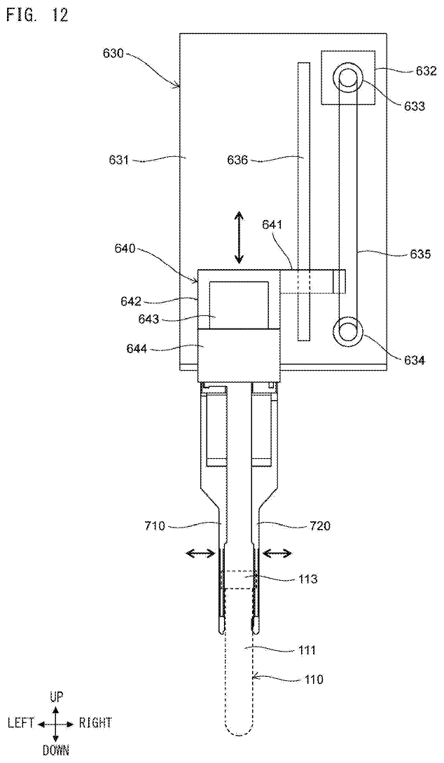

Next, a configuration of the container transfer mechanism 45 of the specimen rearrangement unit 40 will be described with reference to FIGS. 11 and 12.

The container transfer mechanism 74 of the specimen storage unit 70 has a configuration similar to that of the container transfer mechanism 45 of the specimen rearrangement unit 40. That is, the container transfer mechanisms 45 and 74 each include a forward-rearward moving section 610, a leftward-rightward moving section 620, an upward-downward moving section 630, and a holding section 640 as shown in FIGS. 11 and 12. Hereinafter, for convenience sake, the configuration of the container transfer mechanism 45 will be merely described.

FIG. 11 is a plan view schematically showing a configuration of the container transfer mechanism 45 of the specimen rearrangement unit 40. In FIG. 11, components other than the rack 100, the container 110, and the buffer rack 120 are not shown for convenience sake.

The container transfer mechanism 45 includes the forward-rearward moving section 610, the leftward-rightward moving section 620, the upward-downward moving section 630, and the holding section 640. The container transfer mechanism 45 moves one container 110 from the buffer rack 120 in which a plurality of the containers 110 can be held, by using the holding section 640.

The forward-rearward moving section 610 includes a motor and a rail extending in the front-rear direction, and moves the leftward-rightward moving section 620 in the front-rear direction. The leftward-rightward moving section 620 includes a motor and a rail extending in the left-right direction, and moves the upward-downward moving section 630 in the left-right direction. The upward-downward moving section 630 includes a motor and a rail extending in the up-down direction, and moves the holding section 640 in the up-down direction. The holding section 640 is openable and closable, and can be moved in the up-down direction and can be moved in the horizontal direction by the forward-rearward moving section 610, the leftward-rightward moving section 620, and the upward-downward moving section 630. The holding section 640 is configured to be openable and closable and holds the container 110.

FIG. 12 is a side view schematically showing configurations of the upward-downward moving section 630 and the holding section 640.

The upward-downward moving section 630 includes a base plate 631, a motor 632, pulleys 633, 634, a belt 635, and a rail 636.

The motor 632 is implemented by a stepping motor, and disposed at the base plate 631. The pulley 633 is disposed at a shaft, of the motor 632, extending in the front-rear direction. The pulley 634 is disposed at the base plate 631 below the pulley 633. The belt 635 is connected to the pulleys 633, 634, and is moved in the up-down direction according to driving of the motor 632. The rail 636 extends in the up-down direction and is disposed at the base plate 631.

The holding section 640 includes a connection member 641, a base plate 642, a motor 643, a conversion mechanism section 644, and a pair of holding members 710, 720.

The right end of the connection member 641 is fixed to the belt 635. When the belt 635 is moved in the up-down direction, the connection member 641 is moved in the up-down direction while being supported by the rail 636. The connection member 641 is fixed to the base plate 642.

The motor 643 is implemented by a stepping motor, and is disposed at the base plate 642. The rotation shaft of the motor 643 extends in the up-down direction. The conversion mechanism section 644 is disposed at the base plate 642, and the holding members 710, 720 are disposed at the conversion mechanism section 644. The conversion mechanism section 644 is configured to convert the direction in which the motor 643 rotates to directions in which the holding member 710 and the holding member 720 approach each other and separate from each other. Therefore, by driving the motor 643, the holding member 710 and the holding member 720 approach each other and separate from each other. Thus, as shown in FIG. 12, the trunk portion 111 of the container 110 is held by the inner surface of the holding member 710 and the inner surface of the holding member 720.

FIG. 13 is a block diagram illustrating the configuration of the specimen rearrangement unit 40.

The specimen rearrangement unit 40 includes a controller 801, a storage section 802, the display input section 803, a communication section 804, the transportation mechanisms 303, 319 to 322, 352, 367, other mechanisms 805, the sensors 302, 312 to 318, 332, 342, 351, 363 to 366, 368, the reading unit 41, the ascending/descending mechanism 42, the readers 43, 44, and the container transfer mechanism 45.

The controller 801 is, for example, implemented by a CPU. The controller 801 controls each component of hardware of the specimen rearrangement unit 40 by executing a computer program stored in the storage section 802. The storage section 802 is, for example, implemented by an SSD, an HDD, a RAM, or the like. The display input section 803 is, for example, implemented by a touch-panel type display. The display input section 803 may be configured so as to be divided into a display section such as a liquid crystal display and an organic EL display, and an input section such as a mouse and a keyboard. The communication section 804 is, for example, implemented by a network card and is connected to the transportation control unit 80 so as to be able to communicate therewith. Other mechanisms 805 include mechanisms for driving the conveyor belts in the specimen rearrangement unit 40 and a mechanism for driving the stopper 369.

FIG. 14 is a block diagram illustrating the configuration of the specimen storage unit 70.

The specimen storage unit 70 includes a controller 811, a storage section 812, the display input section 813, a communication section 814, the transportation mechanisms 403, 417, 418, 423, 439 to 442, other mechanisms 815, the sensors 402, 412 to 416, 422, 432 to 438, 452, 462, 471, the reading unit 71, the ascending/descending mechanism 72, the reader 73, and the container transfer mechanism 74.

The controller 811 is, for example, implemented by a CPU. The controller 811 controls each component of hardware of the specimen storage unit 70 by executing a computer program stored in the storage section 812. The storage section 812 is, for example, implemented by an SSD, an HDD, a RAM, or the like. The display input section 813 is, for example, implemented by a touch-panel-type display. The display input section 813 may be configured so as to be divided into a display section such as a liquid crystal display and an organic EL display, and an input section such as a mouse and a keyboard. The communication section 814 is, for example, implemented by a network card, and is connected to the transportation control unit 80 so as to be able to communicate therewith. Other mechanisms 815 include mechanisms for driving the conveyor belts in the specimen storage unit 70.

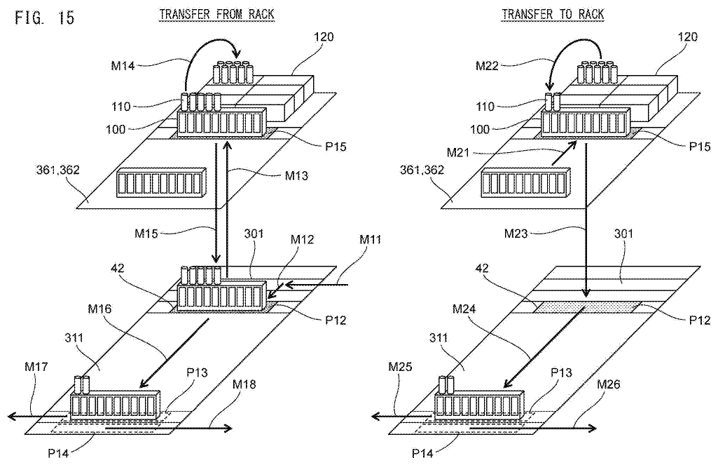

FIG. 15 illustrates a transfer operation performed by the specimen rearrangement unit 40. On the left side in FIG. 15, an operation of transferring the container 110 from the rack 100 to the buffer rack 120 is shown. On the right side in FIG. 15, an operation of transferring the container 110 from the buffer rack 120 to the rack 100 is shown.

As shown on the left side in FIG. 15, in an operation M11, the controller 801 controls the mechanism 805 for driving the conveyor belt of the carrying-in path 301 to carry in the rack 100 to the carrying-in path 301 from the transportation unit 12 disposed adjacently on the right side. In an operation M12, the controller 801 controls the transportation mechanism 303 to transport forward the rack 100 on the carrying-in path 301, and position the rack 100 at the ascending/descending position P12 in the first tier. In an operation M13, the controller 801 controls the ascending/descending mechanism 42 to move the rack 100 positioned at the ascending/descending position P12 to the ascending/descending position P15 in the second tier.

In an operation M14, the controller 801 controls the container transfer mechanism 45 to transfer the container 110 from the rack 100 positioned at the ascending/descending position P15 to the buffer rack 120. In the operation M14, only the containers 110 containing specimens to be processed by the succeeding specimen processing unit are transferred from the rack 100 to the buffer rack 120. After the transfer, in a case where the container 110 is held in the rack 100, an operation M15 and the succeeding operations are performed. Meanwhile, in a case where all of the containers have been transferred to the buffer rack 120, and the rack 100 has become empty, the rack 100 is caused to stay in a waiting state at the ascending/descending position P15, and, in an operation M22, the containers 110 are transferred from the buffer rack 120.

In the operation M15, the controller 801 controls the ascending/descending mechanism 42 to move the rack 100 for which the transfer has ended, to the ascending/descending position P12 in the first tier. In an operation M16, the controller 801 controls the transportation mechanisms 303, and 319 to 322 to transport the rack 100 to the carrying-out position P13 or P14 through the rack waiting region 311. In an operation M17, the controller 801 controls the mechanism 805 for driving the conveyor belt of the carrying-out path 331, to carry out the rack 100 positioned at the carrying-out position P13 to the transportation unit 51 disposed adjacently on the left side. In an operation M18, the controller 801 controls the mechanism 805 for driving the conveyor belt of the carrying-out path 341, to carry out the rack 100 positioned at the carrying-out position P14 to the transportation unit 12 disposed adjacently on the right side.

In a case where the rack 100 stays in the transportation unit 51 disposed adjacently on the left side or the transportation unit 12 disposed adjacently on the right side, and the operation M17 or the operation M18 cannot be performed, the controller 801 controls the transportation mechanisms 303, and 319 to 322, to transport the rack 100 to the rack waiting region 311 and cause the rack 100 to stay in a waiting state in the rack waiting region 311 in the operation M16. Thereafter, in a case where the rack 100 no longer stays in the adjacent unit, and the operation M17 or the operation M18 is performed, the controller 801 controls the transportation mechanisms 303, and 319 to 322, to transport the rack 100 from the rack waiting region 311 to the carrying-out position P13 or P14.

As shown on the right side in FIG. 15, in a case where the container 110 is required to be transferred from the buffer rack 120, the controller 801 controls the transportation mechanism 367 to transport an empty rack reserved in the rack reserving section 361 and the rack setting section 362 to the ascending/descending position P15 in the second tier in an operation M21. In the operation M22, the controller 801 controls the container transfer mechanism 45, to transfer the containers 110 from the buffer rack 120 to the empty rack positioned at the ascending/descending position P15. Thereafter, in operations M23 to M26, as in the same manner as in the operations M15 to M18, the rack 100 is carried out to the transportation unit 51 disposed adjacently on the left side or the transportation unit 12 disposed adjacently on the right side.

In this embodiment, a destination of the rack 100 transported forward along the rack waiting region 311 is any of the smear sample preparation unit 52, the analyzer 62, and the specimen storage unit 70 disposed in the left direction. Therefore, in general, the rack 100 is positioned at the carrying-out position P13, and thereafter carried out to the transportation unit 51 disposed adjacently on the left side.

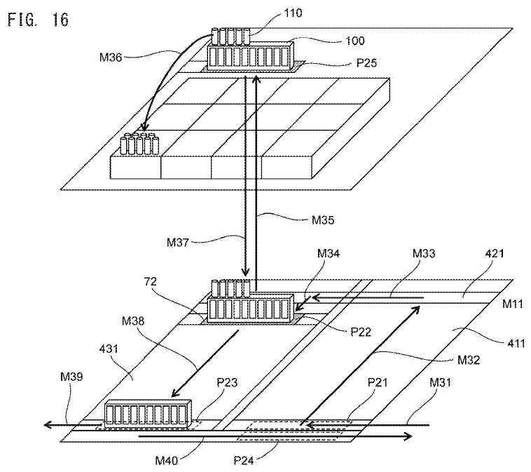

FIG. 16 illustrates a transfer operation performed by the specimen storage unit 70.

In an operation M31, the controller 811 controls the mechanism 815 for driving the conveyor belt of the carrying-in path 401, to carry in the rack 100, from the transportation unit 61 disposed adjacently on the right side, to the carrying-in position P21. In an operation M32, the controller 811 controls the transportation mechanisms 403, 417, and 418, to transport rearward the rack 100 positioned at the carrying-in position P21, and position the rack 100 at the right end of the carrying-in path 421. In an operation M33, the controller 811 controls the mechanism 815 for driving the conveyor belt of the carrying-in path 421, to transport the rack 100 leftward.

In an operation M34, the controller 811 controls the transportation mechanism 423, to transport forward the rack 100 positioned at the carrying-in path 421, and position the rack 100 at the ascending/descending position P22 in the first tier. In an operation M35, the controller 811 controls the ascending/descending mechanism 72, to move the rack 100 positioned at the ascending/descending position P22 to the ascending/descending position P25 in the second tier. In an operation M36, the controller 811 controls the container transfer mechanism 74, to transfer the container 110 from the rack 100 positioned at the ascending/descending position P25 to the archive rack 130. Thus, the rack 100 positioned at the ascending/descending position P25 becomes an empty rack.

In an operation M37, the controller 811 controls the ascending/descending mechanism 72, to move the empty rack to the ascending/descending position P22 in the first tier. In an operation M38, the controller 811 controls the transportation mechanisms 423, and 439 to 442, to transport the empty rack through the rack waiting region 431 to the carrying-out position P23 or P24. In an operation M39, the controller 811 controls the mechanism 815 for driving the conveyor belt of the carrying-out path 451, to carry out the empty rack positioned at the carrying-out position P23 to the collection unit 13 disposed adjacently on the left side. In an operation M40, the controller 811 controls the mechanism 815 for driving the conveyor belt of the carrying-out path 461, to carry out the rack 100 positioned at the carrying-out position P24 to the transportation unit 61 disposed adjacently on the right side.

In a case where the rack 100 stays in the collection unit 13 disposed adjacently on the left side or the transportation unit 61 disposed adjacently on the right side, and the operation M39 or the operation M40 cannot be performed, the controller 811 controls the transportation mechanisms 423, and 439 to 442, to transport the rack 100 to the rack waiting region 431 and cause the rack 100 to stay in a waiting state in the rack waiting region 431 in an operation M38. Thereafter, when the rack 100 no longer stays in the adjacent unit, and the operation M39 or the operation M40 is performed, the controller 811 controls the transportation mechanisms 423, and 439 to 442, to transport the rack 100 from the rack waiting region 431 to the carrying-out position P23 or P24.

In this embodiment, a destination of an empty rack transported forward along the rack waiting region 431 is the collection unit 13 disposed adjacently on the left side in general. However, in a case where the number of the racks 100 in the rack reserving section 361 and the rack setting section 362 of the specimen rearrangement unit 40 is reduced, an empty rack that occurs in the specimen storage unit 70 is carried out to the transportation unit 61 disposed adjacently on the right side and transported to the specimen rearrangement unit 40.

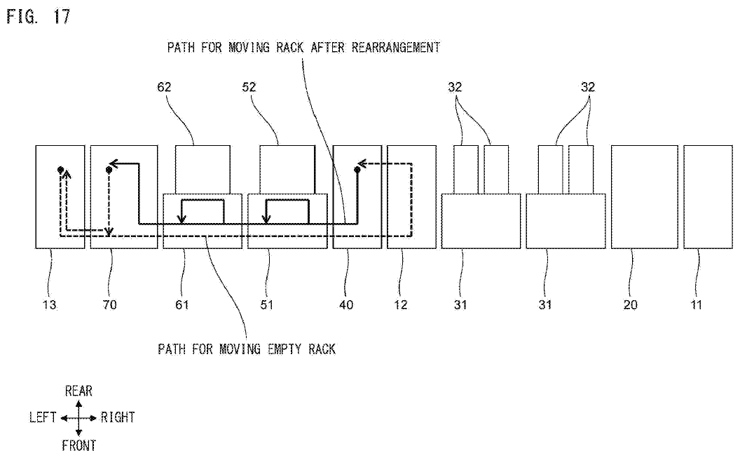

FIG. 17 schematically illustrates a path for transporting the rack 100 between the specimen rearrangement unit 40 and the specimen storage unit 70.

As described above, each of the feeding unit 11, the transportation unit 12, the collection unit 13, the supply unit 20, the transportation units 31, the specimen rearrangement unit 40, the transportation units 51, 61, and the specimen storage unit 70 includes the rack transportation path 1a (see FIG. 1) for transporting the rack 100. The rack 100 is transported along the rack transportation path 1a of each unit, and transportation of the rack 100 is controlled by the transportation control unit 80.

A thick solid line arrow indicates a path for transporting the rack 100 for which rearrangement by the specimen rearrangement unit 40 has ended. The rack 100 for which rearrangement has been performed in the second tier of the specimen rearrangement unit 40, and the rack 100 that is carried out as it is since the rearrangement by the specimen rearrangement unit 40 is not required, are transported to the specimen storage unit 70 by the transportation units 51, 61. All of the containers 110 on the rack 100 are stored in the specimen storage unit 70, and the rack 100 becomes an empty rack. The empty rack that occurs in the specimen storage unit 70 is transported to the collection unit 13 or the specimen rearrangement unit 40.

A thick broken-line arrow indicates a path for transporting an empty rack carried out from the specimen storage unit 70 and the collection unit 13. In a case where, when an empty rack is carried out from the specimen storage unit 70, the number of the racks 100 reserved in the rack reserving section 361 and the rack setting section 362 of the specimen rearrangement unit 40 is less than or equal to a predetermined number, the empty rack is carried out from the specimen storage unit 70 in the right direction, and transported to the transportation unit 12 by the transportation units 51, 61 and the specimen rearrangement unit 40. The transportation unit 12 transports the empty rack rearward, and carries out the empty rack to the specimen rearrangement unit 40 at a rear position. The empty rack carried in by the transportation unit 12 is transported to the rack reserving section 361 and reserved in the rack reserving section 361.

Meanwhile, in a case where, when an empty rack is carried out from the specimen storage unit 70, the number of the racks 100 reserved in the rack reserving section 361 and the rack setting section 362 of the specimen rearrangement unit 40 is greater than the predetermined number, the empty rack is carried out leftward from the specimen storage unit 70 and reserved in the collection unit 13. Thereafter, when the number of the racks 100 reserved in the rack reserving section 361 and the rack setting section 362 of the specimen rearrangement unit 40 becomes less than or equal to the predetermined number, the empty rack in the collection unit 13 is transported to the transportation unit 12 through the specimen storage unit 70 by the transportation units 51, 61, carried out to the specimen rearrangement unit 40 by the transportation unit 12, and reserved in the rack reserving section 361 of the specimen rearrangement unit 40.

### Effects of the Embodiment

As shown in FIG. 15, in the specimen rearrangement unit 40, the container transfer mechanism 45 transfers the container 110 (specimen container), to the buffer rack 120 (second rack) disposed in the second tier, from the rack 100 (first rack) that has been moved by the ascending/descending mechanism 42 from the ascending/descending position P12 (first ascending/descending position) at which the rack 100 in the first tier is disposed to the ascending/descending position P15 (second ascending/descending position) at which the rack 100 in the second tier is disposed. In the first tier, the rack waiting region 311 in which the rack 100 (first rack) is caused to stay in a waiting state is disposed. In this configuration, a rack waiting region in which the rack 100 is caused to stay in a waiting state need not be provided outside the specimen rearrangement unit 40. Therefore, the installation area of the specimen testing system 1 can be effectively reduced while process efficiency is maintained high.

As shown in FIG. 16, in the specimen storage unit 70, the container transfer mechanism 74 transfers the container 110 (specimen container), to the archive rack 130 (second rack) disposed in the second tier, from the rack 100 (first rack) that has been moved by the ascending/descending mechanism 72 from the ascending/descending position P22 (first ascending/descending position) at which the rack 100 in the first tier is disposed to the ascending/descending position P25 (second ascending/descending position) at which the rack 100 in the second tier is disposed. In the first tier, the rack waiting region 431 in which the rack 100 (first rack) is caused to stay in a waiting state is disposed. In this configuration, a rack waiting region in which the rack 100 is caused to stay in a waiting state need not be provided outside the specimen storage unit 70. Therefore, the installation area of the specimen testing system 1 can be effectively reduced while process efficiency is maintained high.

As shown in FIG. 3, in the specimen rearrangement unit 40, the rack waiting region 311 is a rectangular region between the ascending/descending position P12 (first ascending/descending position) and the carrying-out position P13. In this configuration, the rack 100 moved between the first tier and the second tier can be smoothly moved quickly to the carrying-out position P13, P14.

As shown in FIG. 6, in the specimen storage unit 70, the rack waiting region 431 is a rectangular region between the ascending/descending position P22 (first ascending/descending position) and the carrying-out position P23. In this configuration, the rack 100 moved between the first tier and the second tier can be smoothly moved quickly to the carrying-out position P23, P24.

As shown in FIG. 3, in the specimen rearrangement unit 40, the transportation mechanisms 303, and 319 to 322 (first transportation mechanism) move the rack 100 (first rack) moved between the first tier and the second tier, along the rack waiting region 311, in the transverse direction of the rack 100 (first rack). In this configuration, the length of the rack waiting region 311 can be reduced as compared with a case where the rack 100 is moved in the longitudinal direction of the rack 100.

As shown in FIG. 6, in the specimen storage unit 70, the transportation mechanisms 423, and 439 to 442 (first transportation mechanism) move the rack 100 (first rack) moved between the first tier and the second tier, along the rack waiting region 431, in the transverse direction of the rack 100 (first rack). In this configuration, the length of the rack waiting region 431 can be reduced as compared with a case where the rack 100 is moved in the longitudinal direction of the rack 100.

As shown in FIG. 3, in the specimen rearrangement unit 40, the carrying-in path 301 for carrying in the rack 100 (first rack), and the transportation mechanism 303 (second transportation mechanism) for transporting the rack 100 (first rack) that is carried into the carrying-in path 301, to the ascending/descending position P12 (first ascending/descending position), are disposed in the first tier on the side opposite to the rack waiting region 311 side with respect to the ascending/descending position P12 (first ascending/descending position). In this configuration, the succeeding rack 100 can be caused to stay in a waiting state at the carrying-in path 301 while the rack 100 is moved upward/downward at the ascending/descending position P12. Therefore, the process for the succeeding rack 100 can be quickly performed to enhance process efficiency.

As shown in FIG. 6, in the specimen storage unit 70, the carrying-in path 421 for carrying in the rack 100 (first rack), and the transportation mechanism 423 (second transportation mechanism) for transporting the rack 100 (first rack) that is carried into the carrying-in path 421, to the ascending/descending position P22 (first ascending/descending position), are disposed in the first tier on the side opposite to the rack waiting region 431 side with respect to the ascending/descending position P22 (first ascending/descending position) in the moving direction. In this configuration, the succeeding rack 100 can be caused to stay in a waiting state at the carrying-in position while the rack 100 is moved upward/downward at the ascending/descending position P22. Therefore, the process for the succeeding rack 100 can be quickly performed to enhance process efficiency.

As shown in FIG. 3, the specimen rearrangement unit 40 includes the reader 41d for reading, at the carrying-in path 301, identification information of the container 110 (specimen container) held in the rack 100 (first rack). In this configuration, the identification information can be read from the rack 100 while the rack 100 stays in a waiting state at the carrying-in path 301. Thus, the succeeding process for the succeeding rack 100 can be quickly performed to enhance process efficiency.

As shown in FIG. 6, the specimen storage unit 70 includes the reader 71d for reading, at the carrying-in path 421, identification information of the container 110 (specimen container) held in the rack 100 (first rack). In this configuration, the identification information can be read from the rack 100 while the rack 100 stays in a waiting state at the carrying-in path 421. Thus, the succeeding process for the succeeding rack 100 can be quickly performed to enhance process efficiency.

As shown in FIGS. 5 and 15, in the specimen rearrangement unit 40, the second tier 49 is disposed above the first tier 48. Thus, in the specimen testing system 1, the height of the rack transportation path 1a can be the height of the carrying-out position in the first tier, and the height of the rack transportation path 1a can be reduced.

As shown in FIGS. 8 and 16, in the specimen storage unit 70, the second tier 79 is disposed above the first tier 78. Thus, in the specimen testing system 1, the height of the rack transportation path 1a can be the height of the carrying-out position in the first tier, and the height of the rack transportation path 1a can be reduced.

As shown in FIG. 4, in the specimen rearrangement unit 40, the rack reserving section 361 is disposed in the second tier, and reserves empty racks 100 (third racks). The transportation mechanism 367 (third transportation mechanism) transports the rack 100 (third rack) reserved in the rack reserving section 361 to the ascending/descending position P15 (second ascending/descending position). The container 110 (specimen container) having been transferred to the buffer rack 120 (second rack) is transferred to the rack 100 (third rack) by the container transfer mechanism 45. The rack 100 (third rack) to which the containers 110 (specimen containers) have been transferred is moved to the ascending/descending position P12 (first ascending/descending position) by the ascending/descending mechanism 42 and transported through the rack waiting region 311 to the carrying-out position P13 by the transportation mechanisms 303, and 319 to 322 (first transportation mechanism). In this configuration, the rearrangement of the containers 110 can be efficiently performed while the installation area of the specimen testing system 1 is reduced.

As shown in FIG. 4, in the specimen rearrangement unit 40, the rack reserving section 361 is disposed on the side opposite to the buffer rack 120 (second rack) side with respect to the ascending/descending position P15 (second ascending/descending position). In this configuration, both the rack reserving section 361 and the buffer rack 120 can be disposed near the ascending/descending position P15 in the second tier, and rearrangement of the containers 110 can be efficiently performed.

As shown in FIG. 4, the specimen rearrangement unit 40 includes the rack setting section 362 in which an operator is allowed to set an empty rack (third rack), and the transportation mechanism 367 (fourth transportation mechanism) for transporting the empty rack (third rack) set in the rack setting section 362, to the rack reserving section 361. In this configuration, the specimen rearrangement unit 40 can be smoothly refilled with empty racks.

In this embodiment, the transportation mechanism 367 (third transportation mechanism) for transporting an empty rack (third rack) reserved in the rack reserving section 361 to the ascending/descending position P15 in the second tier, doubles as a transportation mechanism (fourth transportation mechanism) for transporting an empty rack (third rack) set in the rack setting section 362, to the rack reserving section 361. However, instead of this configuration, a transportation mechanism (fourth transportation mechanism) for transporting an empty rack from the rack setting section 362 to the rack reserving section 361 may be separately disposed.

As shown in FIG. 4, in the specimen rearrangement unit 40, the rack setting section 362, the rack reserving section 361, the ascending/descending position P15 (second ascending/descending position), and the buffer rack 120 (second rack) are aligned in order, respectively, from the front side of the device. In this configuration, the ascending/descending position P15 in the second tier is on the depth side of the device, whereby the width, in the front-rear direction, of the rack reserving section 361 can be assuredly widened. Therefore, many empty racks can be reserved in the rack reserving section 361. Furthermore, the rack setting section 362 is disposed at the forefront side of the device, whereby an operator is allowed to smoothly set an empty rack in the rack setting section 362.

As shown in FIG. 3, in the specimen rearrangement unit 40, the rack waiting region 311 is disposed on the front side of the specimen rearrangement unit 40 (device) as compared with the ascending/descending position P12 (first ascending/descending position), and the rack transportation path 1a (see FIG. 1) of each of the transportation units 12 and 51 disposed to the right and the left, respectively, of the specimen rearrangement unit 40 is connected to the front side of the specimen rearrangement unit 40 (device). In this configuration, since the ascending/descending position P12 in the first tier is on the depth side of the device, the length, in the front-rear direction, of the rack waiting region 311 disposed forward of the ascending/descending position P12 can be assuredly increased. Therefore, many racks 100 can be caused to stay in a waiting state in the rack waiting region 311.

As shown in FIG. 7, in the specimen storage unit 70, the tray 75 is disposed in the second tier so as to be movable to the outside of the specimen storage unit 70 (device), and the archive rack 130 (second rack) is placed in the tray 75. In this configuration, an operator is allowed to smoothly take out the stored container 110 by moving the tray 75 to the outside.

As shown in FIG. 7, in the specimen storage unit 70, the archive rack 130 (second rack) is disposed on the front side of the specimen storage unit 70 (device) as compared with the ascending/descending position P25 (second ascending/descending position). In this configuration, an operator is allowed to smoothly draw out the tray 75 and smoothly take out the stored container 110. Furthermore, the ascending/descending position P25 in the second tier is on the depth side of the device, whereby the archive rack 130 can be disposed in a wide region on the front side of the device. Therefore, an increased number of the containers 110 can be stored.

As shown in FIG. 6, in the specimen storage unit 70, the rack waiting region 431 is disposed on the front side of the specimen storage unit 70 (device) as compared with the ascending/descending position P22 (first ascending/descending position), and the rack transportation path 1a (see FIG. 1) of each of the transportation unit 61 and the collection unit 13 disposed to the right and the left, respectively, of the specimen storage unit 70 is connected to the front side of the specimen storage unit 70 (device). In this configuration, the ascending/descending position P22 in the first tier is on the depth side of the device, whereby the length, in the front-rear direction, of the rack waiting region 431 disposed forward of the ascending/descending position P22 can be assuredly increased. Therefore, many racks 100 can be caused to stay in a waiting state in the rack waiting region 431.

As shown in FIG. 7, in the specimen storage unit 70, the take-out section 472 for allowing the container 110 (specimen container) to be taken out to the outside is disposed in the second tier, and the container transfer mechanism 74 transfers the container 110 (specimen container) to be taken out, from the archive rack 130 (second rack), to the take-out section 472. In this configuration, a predetermined container 110 among the stored containers 110 can be taken out.

As shown in FIG. 1, the transportation units 12, 31 include the rack transportation path 1a, and transport the rack 100 between the measurement units 32 and the specimen rearrangement unit 40. In this configuration, the rack 100 can be smoothly transported between the measurement units 32 and the specimen rearrangement unit 40. The transportation units 51, 61 include the rack transportation path 1a, and transport the rack 100 between the smear sample preparation unit 52 and the analyzer 62 (specimen processing unit), and the specimen rearrangement unit 40. In these configurations, the rack 100 can be smoothly transported between the smear sample preparation unit 52 and the analyzer 62 (specimen processing unit), and the specimen rearrangement unit 40.

As shown in FIG. 1, the transportation units 12, 31, 51, 61 and the specimen rearrangement unit 40 (transportation unit) include the rack transportation path 1a, and transport the rack 100 between the measurement units 32 and the specimen storage unit 70. In this configuration, the rack 100 can be smoothly transported between the measurement units 32 and the specimen storage unit 70. The transportation units 51, 61 include the rack transportation path 1a, and transport the rack 100 between the smear sample preparation unit 52 and the analyzer 62 (specimen processing unit), and the specimen storage unit 70. In these configurations, the rack 100 can be smoothly transported between the smear sample preparation unit 52 and the analyzer 62 (specimen processing unit), and the specimen storage unit 70.

The transportation units 12, 51, 61 and the collection unit 13 (transportation unit) include the rack transportation path 1a, and transport the rack 100 between the specimen rearrangement unit 40 and the specimen storage unit 70, as shown in FIG. 17. In this configuration, the rack 100 can be smoothly transported between the specimen rearrangement unit 40 and the specimen storage unit 70.

### Modification 1

In the specimen testing system 1 in FIG. 1, the specimen storage unit 70, the collection unit 13, the feeding unit 11, the supply unit 20, the two transportation units 31, the transportation unit 12, the specimen rearrangement unit 40, and the transportation units 51, 61 may be aligned in line toward the left direction in order, respectively, so as to be adjacent to each other.

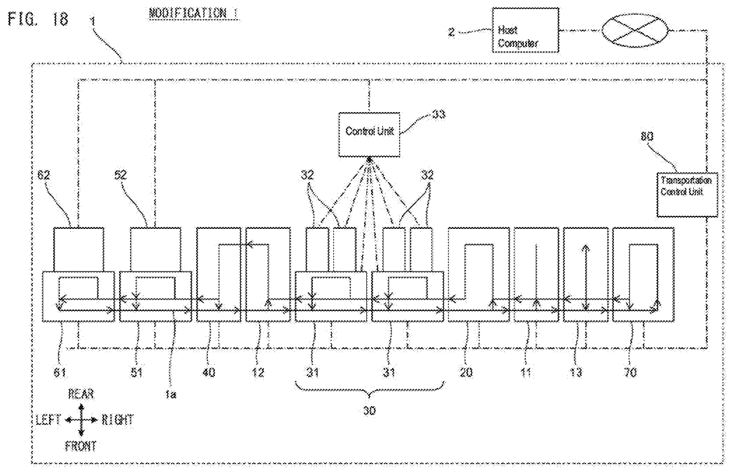

FIG. 18 schematically illustrates a configuration of the specimen testing system 1 according to a modification 1.

Also in this modification, as in FIG. 1, the transportation units 12, 31 transport the rack 100 between the measurement units 32 and the specimen rearrangement unit 40, and the transportation units 51, 61 transport the rack 100 between the smear sample preparation unit 52 and the analyzer 62 (specimen processing unit), and the specimen rearrangement unit 40. Meanwhile, the transportation units 31, the supply unit 20, the feeding unit 11, and the collection unit 13 (transportation unit) transport the rack 100 between the measurement units 32 and the specimen storage unit 70. Furthermore, the transportation units 51, 61, the specimen rearrangement unit 40, the transportation unit 12, the transportation units 31, the supply unit 20, the feeding unit 11, and the collection unit 13 (transportation unit) transport the rack 100 between the smear sample preparation unit 52 and the analyzer 62 (specimen processing unit), and the specimen storage unit 70. In this configuration, as in the embodiment, the rack 100 can be smoothly transported.

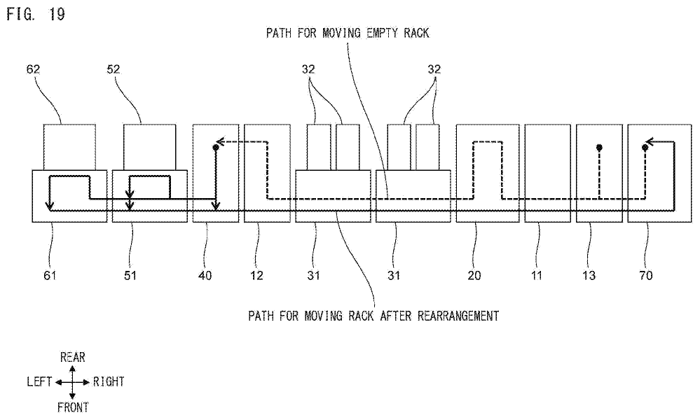

The collection unit 13, the feeding unit 11, the supply unit 20, the two transportation units 31, the transportation unit 12, and the transportation units 51, 61 (transportation unit) transport the rack 100 between the specimen rearrangement unit 40 and the specimen storage unit 70. A path in this case will be described with reference to FIG. 19.

FIG. 19 schematically illustrates a path for transporting the rack 100 between the specimen rearrangement unit 40 and the specimen storage unit 70 according to the modification 1. The rack 100 is transported along the rack transportation path 1a (see FIG. 18) of each unit, and the transportation of the rack 100 is controlled by the transportation control unit 80.

A thick solid line arrow indicates a path for transporting the rack 100 for which rearrangement has ended in the specimen rearrangement unit 40. The rack 100 for which rearrangement has been performed in the second tier of the specimen rearrangement unit 40, and the rack 100 that is carried out as it is since rearrangement is not required to be performed by the specimen rearrangement unit 40 are transported as appropriate by the transportation units 51, 61, and are thereafter transported to the specimen storage unit 70 by the specimen rearrangement unit 40, the transportation unit 12, the two transportation units 31, the supply unit 20, the feeding unit 11, and the collection unit 13. All of the containers 110 on the rack 100 are stored in the specimen storage unit 70, and the rack 100 becomes an empty rack. The empty rack that occurs in the specimen storage unit 70 is transported to the collection unit 13 or the specimen rearrangement unit 40.

A thick broken-line arrow indicates a path for transporting the rack 100 carried out from the specimen storage unit 70 and the collection unit 13. In a case where, when the empty rack is carried out from the specimen storage unit 70, the number of the racks 100 reserved in the rack reserving section 361 and the rack setting section 362 of the specimen rearrangement unit 40 is less than or equal to the predetermined number, the empty rack is carried out leftward from the specimen storage unit 70, and is transported to the specimen rearrangement unit 40 by the collection unit 13, the feeding unit 11, the supply unit 20, the two transportation units 31, and the transportation unit 12.

Meanwhile, in a case where, when the empty rack is carried out from the specimen storage unit 70, the number of the racks 100 reserved in the rack reserving section 361 and the rack setting section 362 of the specimen rearrangement unit 40 is greater than the predetermined number, the empty rack is carried out leftward from the specimen storage unit 70 and reserved in the collection unit 13. Thereafter, when the number of the racks 100 reserved in the rack reserving section 361 and the rack setting section 362 of the specimen rearrangement unit 40 becomes less than or equal to the predetermined number, the empty rack in the collection unit 13 is transported to the specimen rearrangement unit 40 by the feeding unit 11, the supply unit 20, the two transportation units 31, and the transportation unit 12 without passing through the specimen storage unit 70.

Thus, also in the configuration shown in FIGS. 18, 19, the collection unit 13, the feeding unit 11, the supply unit 20, the two transportation units 31, the transportation unit 12, and the transportation units 51, 61 transport the rack 100 between the specimen rearrangement unit 40 and the specimen storage unit 70. In this configuration, the rack 100 can be smoothly transported between the specimen rearrangement unit 40 and the specimen storage unit 70.

### Modification 2

The specimen testing system 1 in FIG. 1 may include only the specimen rearrangement unit 40 among the specimen rearrangement unit 40 and the specimen storage unit 70. That is, in the specimen testing system 1 shown in FIG. 1, the specimen storage unit 70 may be omitted.

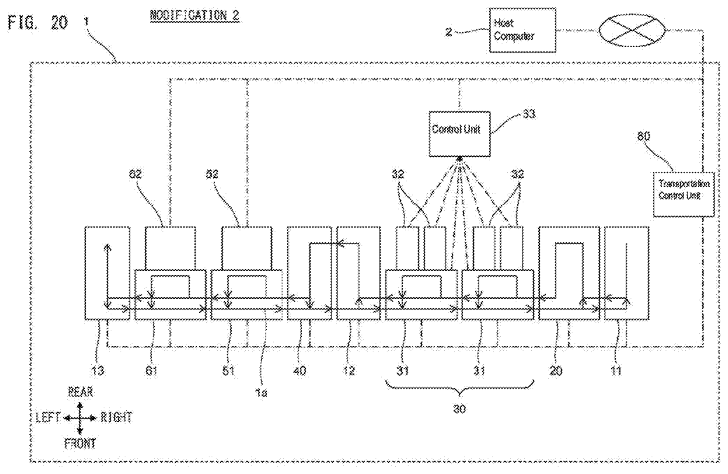

FIG. 20 schematically illustrates a configuration of the specimen testing system 1 according to a modification 2.

In this modification, the rack 100 holding specimens that have been tested is transported leftward, and is collected in the collection unit 13. Also in the configuration illustrated in FIG. 20, the transportation units 51, 61 include the rack transportation path 1a, and transport the rack 100 between the smear sample preparation unit 52 and the analyzer 62 (specimen processing unit), and the specimen rearrangement unit 40. Thus, the rack 100 can be smoothly transported between the specimen processing unit and the specimen rearrangement unit 40.

### Modification 3

The specimen testing system 1 in FIG. 1 may include only the specimen storage unit 70 among the specimen rearrangement unit 40 and the specimen storage unit 70. That is, in the specimen testing system 1 illustrated in FIG. 1, the specimen rearrangement unit 40 and the transportation unit 12 may be omitted.

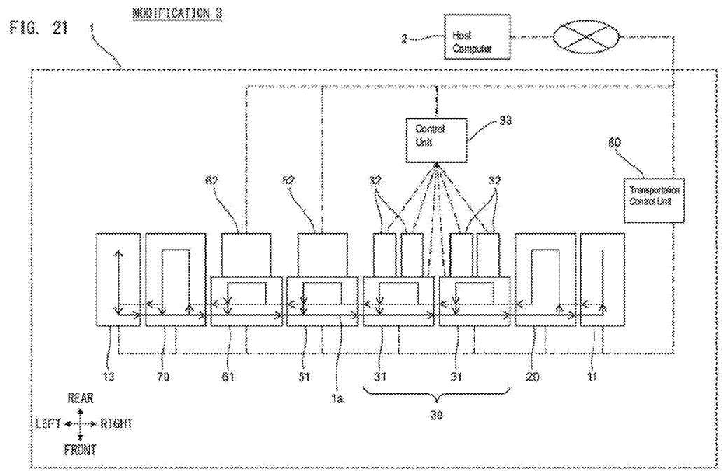

FIG. 21 schematically illustrates a configuration of the specimen testing system 1 according to a modification 3.

In this modification, the rack 100 holding specimens that have been tested is transported leftward, and the containers 110 held in the rack 100 are stored in the specimen storage unit 70. Also in the configuration illustrated in FIG. 21, the transportation units 51, 61 include the rack transportation path 1a, and transport the rack 100 between the smear sample preparation unit 52 and the analyzer 62 (specimen processing unit), and the specimen storage unit 70. Thus, the rack 100 can be smoothly transported between the specimen processing unit and the specimen storage unit 70.

### Other Modifications

In the above-described embodiment, the second tier is disposed above the first tier in the specimen rearrangement unit 40. However, the second tier may be disposed below the first tier. The second tier is disposed above the first tier in the specimen storage unit 70. However, the second tier may be disposed below the first tier.

In the specimen rearrangement unit 40, in a case where the width, in the front-rear direction, of the intermediate path 304 is set so as to reserve the rack 100, the rack 100 from which the rack ID and the specimen IDs have been read in the carrying-in path 301 may be reserved in the intermediate path 304. Similarly, in the specimen storage unit 70, in a case where the width, in the front-rear direction, of the intermediate path 424 is set so as to reserve the rack 100, the rack 100 from which the rack ID and the specimen IDs have been read in the carrying-in path 421 may be reserved in the intermediate path 424. In these cases, while the rack 100 is moved upward/downward at the ascending/descending position P12, P22, the succeeding rack 100 can be caused to be in a waiting state in the intermediate path 304, 424. Therefore, the process for the succeeding rack 100 can be quickly performed, and the process efficiency can be further enhanced.

As shown in FIGS. 3 and 6, the ascending/descending mechanism 42, 72 moves the support portion 42a, 72a that supports the lower surface of the rack 100 in the up-down direction to move the rack 100 upward/downward. However, instead of this configuration, the ascending/descending mechanism 42, 72 may move holding portions that hold the left and the right side surfaces of the rack 100 or the front and the rear side surfaces thereof in the up-down direction to move the rack 100 upward/downward.

As shown in FIG. 12, the holding members 710 and 720 approach each other and separate from each other in the left-right direction to hold the container 110. However, instead of this configuration, the holding members 710 and 720 may approach each other and separate from each other in the front-rear direction to hold the container 110. Furthermore, instead of the holding members 710 and 720 being used, the container 110 may be held by three or more bar-like members that approach the container 110 and separate from the container 110 in a planar view.

The rack waiting regions 311, 431, the movement path 411, the rack reserving section 361, and the rack setting section 362 are each configured as a plate-member having the upper surface parallel to the horizontal plane. However, the rack waiting regions 311, 431, the movement path 411, the rack reserving section 361, and the rack setting section 362 may be configured as a conveyor belt that moves in the front-rear direction. In this case, a transportation mechanism for transporting the rack 100 on the rack waiting regions 311, 431, the movement path 411, the rack reserving section 361, and the rack setting section 362 includes a motor for driving the conveyor belt.

As shown in FIGS. 4 and 7, the container 110 is transferred at the ascending/descending position P15 in the second tier in the specimen rearrangement unit 40, and at the ascending/descending position P25 in the second tier in the specimen storage unit 70. However, instead of this configuration, the container 110 may be transferred at another position, in the second tier, different from the ascending/descending position P15, P25.

The specimen rearrangement unit 40 and the transportation unit 12 are structured as separate units. However, the specimen rearrangement unit 40 and the transportation unit 12 may be structured as one unit. In this case, the first tier of the specimen rearrangement unit 40 and the transportation unit 12 are integrated with each other. Thus, as in the above-described embodiment, the rack 100 is caused to stay in a waiting state in the rack waiting region 311 in the first tier while the container 110 is transferred in the second tier. Thus, the installation area of the specimen testing system 1 can be effectively reduced.

Various modifications of the embodiments of the present invention can be made as appropriate, without departing from the scope of the technological idea defined by the claims.

What is claimed is:

1. A specimen testing system for testing specimens and preparing smeared specimens, the specimen testing system comprising:
a rack transportation path configured in a horizontal plane and having a start and an end at horizontally different locations, wherein the rack transportation path has a specimen testing section and a specimen smearing section arranged subsequent to the specimen testing section along the rack transportation path;
a blood cell counter located in the specimen testing section of the rack transportation path and configured to count blood cells in the specimens, the specimens being stored in specimen containers including: a first type of specimen containers that each store a first type of specimen therein that has undergone testing; a second type of specimen container that stores a second type of specimen therein, which is included in the first type of specimens, that has undergone the testing and does not require smearing; and a third type of specimen container that stores a third type of specimen therein, which is included in the first type of specimens, that has undergone the testing and requires the smearing;
a smeared sample preparator located in the specimen smearing section of the rack transportation path and configured to smear the third type of specimen;
a first rack transporter configured to transport, along the rack transportation path, racks each capable of holding a number of specimen containers therein, wherein the racks include: a first type of rack that holds the first type of specimen container; a second type of rack that only holds the second type of specimen container; a third type of rack that only holds the third type of specimen container; and a fourth type of rack that holds no specimen container;
a specimen container rearranger located between the specimen testing section and the specimen smearing section and including first and second rearrangement floors vertically arranged one over the other, each of the first and second rearrangement floors being extensive to intersect the rack transportation path at a non-zero angle, wherein
the first rearrangement floor has: a rack receiving area configured to receive the first type of rack transported from the specimen testing section; a rack waiting area configured to pool the second and third types of racks therein for transport back to the rack transportation path, wherein the third type of rack is held in the rack waiting area until the smeared sample preparator becomes accepting the third type of specimen for smearing; and a second rack transporter configured to transport the second and third types of racks along the rack waiting area, and
the second rearrangement floor has: a container buffering rack configured to pool the third type of specimen container therein; and an empty rack buffering area positioned separately from the container buffering rack and configured to pool the fourth type of rack therein;
a container loader configured to unload the third type of specimen container from the first type of rack positioned in the second rearrangement floor to the container buffering rack and load the third type of specimen container from the container buffering rack to the fourth type of rack positioned in the second rearrangement floor; and
an elevator configured to vertically transport the rack between the first rearrangement floor and the second rearrangement floor.

2. The specimen testing system of claim 1, wherein the rack waiting area extends in a rectangular shape along a length of the first rearrangement floor.

3. The specimen testing system of claim 2, wherein the rack is configured to hold the number of the specimen containers in line along a length direction of the rack, and the second rack transporter of the first rearrangement floor is configured to transport the rack along the rack waiting area in a direction perpendicular to the length direction of the rack to accumulate the racks in the rack waiting area in the direction perpendicular to the length direction of the rack.

4. The specimen testing system of claim 1, wherein the first rearrangement floor further incudes a vertical transport position at which the elevator vertically transports the rack between the first and second rearrangement floors,
the rack receiving area and the rack waiting area are arranged on opposite sides of the vertical transport position, and
the first rearrangement floor is provided with a fourth rack transporter configure to transport the rack from the rack receiving area to the vertical transport position.

5. The specimen testing system of claim 4, wherein the first rearrangement floor has a reader at the rack receiving area configured to distinguish the second and third types of containers held in the first type of rack received at the rack receiving area.

6. The specimen testing system of claim 1, wherein the first and second rearrangement floors extend in parallel to each other in vertical alignment with each other.

7. The specimen testing system of claim 1, wherein the container buffering rack and the empty rack buffering area are arranged on opposite sides of the second rearrangement floor.

8. The specimen testing system of claim 1, wherein the second rearrangement floor is configured such that an operator is allowed to place the fourth type of rack in the empty rack buffering area.

9. The specimen testing system of claim 1, further comprising a specimen container collector that comprises first and second collection floors vertically arranged one over the other, wherein the specimen containers include a fifth type of specimen container that stores a fifth type of specimen that has undergone the testing and the smearing, and the racks include a fifth type of rack that only holds the fifth type of specimen container, wherein
the first collection floor has: a second rack receiving area configured to receive the second type of rack and the fifth type of rack; and a fifth rack transporter configured to transport the fourth type of rack to the rack transportation path, and
the second collection floor has: a container archive rack configured to pool the second type of specimen container and the fifth type of specimen container therein; a container unloader configured to unload the second type of specimen container from the second type of rack to the container archive are and the fifth type of specimen container from the fifth type of rack to the container archive area; and
a second elevator configured to vertically transport the rack between the first collection floor and the second collection floor.

10. The specimen testing system of claim 9, wherein the first collection floor is provided with a sixth rack transporter configure to transport the fifth type of rack from the second rack receiving area for vertical transport by the second elevator.

11. The specimen testing system of claim 1, further comprising a controller programmed to perform a specimen container rearrangement operation that includes:
operating the elevator to, from the first rearrangement floor to the second rearrangement floor, vertically transport the first type of rack including at least one third type of specimen container and received at the rack receiving area;
operating the container loader to unload the third type of specimen container to the container buffering rack from the vertically transported first type of rack;
operating the elevator to vertically transport the second type of rack to the first rearrangement floor after the container loader unloads the third type of specimen container to the container buffering rack from the vertically transported first type of rack;
operating the container loader to load the third type of specimen container from the container buffering rack to the fourth type of rack in the second rearrangement floor;
operating the elevator to vertically transport the third type of rack to the first rearrangement floor after the container loader loads the third type of specimen container from the container buffering rack to the fourth type of rack;
operating the second rack transporter to transport the second and third types of racks held in the rack waiting area in the first rearrangement floor to the rack transportation path; and
operating the first rack transporter to transport the second type of rack along the rack transportation path to bypass the specimen smearing section and transport the third type of rack along the rack transportation path to deliver the third type of rack to the specimen smearing section for specimen smearing.

12. The specimen testing system of claim 9, further comprising a controller programmed to perform a container collection operation that includes:
operating the second elevator to vertically transport the second type of rack received at the second rack receiving area from the first collection floor to the second collection floor;
operating the container unloader to unload the second type of specimen container to the container archive rack from the vertically transported second type of rack;
operating the second elevator to vertically transport the fourth type of rack to the first collection floor after the container unloader unloads the second type of specimen container to the container archive rack from the vertically transported second type of rack;
operating the second elevator to vertically transport the fifth type of rack received at the second rack receiving area from the first collection floor to the second collection floor;
operating the container unloader to unload the fifth type of specimen container to the container archive rack from the vertically transported fifth type of rack;
operating the second elevator to vertically transport the fourth type of rack to the first collection floor after the container unloader unloads the fifth type of specimen container to the container archive rack from the vertically transported fifth type of rack; and
operating the fifth container transporter to transport the fourth type of rack in the first collection floor to the rack transportation path.
